(19) United States
(12) Patent Application Publication
(10) Pub. No.: US 2013/0275426 A1
(43) Pub. Date: Oct. 17, 2013

(54) Information System for Nutritional Substances

(71) Applicant: Eugenio Minvielle, Rye, NY (US)

(72) Inventor: Eugenio Minvielle, Rye, NY (US)

(21) Appl. No.: 13/771,004

(22) Filed: Feb. 19, 2013

Related U.S. Application Data
(63) Continuation-in-part of application No. 13/485,883, filed on May 31, 2012.
(60) Provisional application No. 61/624,915, filed on Apr. 16, 2012.
(60) Provisional application No. 61/624,925, filed on Apr. 16, 2012.
(60) Provisional application No. 61/624,934, filed on Apr. 16, 2012.

(51) Int. Cl. G06F 17/30

(52) U.S. Cl. CPC G06F 17/30595
USPC 707/736

(57) ABSTRACT

An information system for nutritional substances obtains information regarding a nutritional substance from the creation of the nutritional substance, the preservation of the nutritional substance, the transformation of the nutritional substance, the conditioning of the nutritional substance, and the consumption of the nutritional substances. The information system stores and provides this information to the various constituents of the nutritional substance supply system.

### RELATED PATENT APPLICATIONS

This application is a continuation-in-part of U.S. patent application Ser. No. 13/485,883, filed May 31, 2012, which claims benefit under 35 U.S.C. 119(e) of U.S. Provisional Patent Application Ser. No. 61/624,915, filed Apr. 16, 2012; U.S. Provisional Patent Application Ser. No. 61/624,925, filed Apr. 16, 2012; and U.S. Provisional Patent Application, 61/624,934, filed Apr. 16, 2012; and is also related to U.S. patent application Ser. No. 13/732,050, filed Dec. 31, 2012, which is a continuation-in-part of Utility application Ser. No. 13/485,878 filed May 31, 2012, which claims priority to U.S. Provisional Patent Application Ser. No. 61/624,800, filed Apr. 16, 2012; U.S. Provisional Patent Application Ser. No. 61/624,980, filed Apr. 16, 2012; and U.S. Provisional Patent Application, 61/624,989, filed Apr. 16, 2012. This application is also related to U.S. patent application Ser. No. 13/750,804, filed Jan. 25, 2013, which is a continuation-in-part of U.S. patent application Ser. No. 13/485,850, filed May 31, 2012, which claims priority to U.S. Provisional Patent Application Ser. No. 61/624,993 filed Apr. 16, 2012; U.S. Provisional Patent Application Ser. No. 61/624,999, filed Apr. 16, 2012; and U.S. Provisional Patent Application, 61/625,009, filed Apr. 16, 2012, the contents of which are incorporated herein by reference in their entirety.

### FIELD OF THE INVENTION

The present inventions relate to an information system for collecting, transmitting and acting upon information during the harvesting, preserving, transforming, conditioning and/or consumption of nutritional substance.

### BACKGROUND OF THE INVENTION

Nutritional substances are traditionally grown (plants), raised (animals) or synthesized (synthetic compounds). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry: growers, packagers, processors, distributors, retailers, and preparers work separately, and either shares no information, or very little information, between themselves. There is generally no consumer access to, and little traceability of, information regarding the creation and/or origin, preservation, processing, preparation, or consumption of nutritional substances. In particular, there is no information available to a consumer, at the moment the consumer wants to know, regarding changes (typically degradation) in nutritional, organoleptic, or aesthetic values of nutritional substances or regarding residual nutritional, organoleptic, or aesthetic values of the nutritional substance. Further, there is no information available to the consumer regarding changes in nutritional, organoleptic, or aesthetic values of nutritional substances or regarding residual nutritional, organoleptic, or aesthetic values of the nutritional substance after they have been conditioned, and no way for the consumer to know what conditioning protocol will achieve the nutritional, organoleptic, or aesthetic values he desires. It would be desirable for such information be available to the consumers of nutritional substances at any desired moment, as well as all participants in the food and beverage industry—the nutritional substance supply system. Further, it would be of great benefit for consumers to have the ability to share information with desired entities outside the nutritional substance supply system regarding nutritional substances they are considering for consumption or have already consumed. For example, a consumer may wish to share such nutritional substance information with their physician in order for the physician to better diagnose or treat him. The consumer could share such nutritional substance information with a health and fitness organization or website in which he is a member in order to verify if a particular nutritional substance meets his specific dietary needs. The consumer may share such information by granting access to a database with his specific nutritional substance consumption data or might query the desired entity regarding the suitability of nutritional substances being considered for purchase or consumption.

While the nutritional substance supply system has endeavored over the last 50 years to increase the caloric content of nutritional substances produced (which has help reduce starvation in developing countries, but has led to obesity problems in developed countries), maintaining, or increasing, the nutritional content of nutritional substances has been a lower priority. Caloric content refers to the energy in nutritional substances, commonly measured in calories. The caloric content could be represented as sugars and/or carbohydrates in the nutritional substances. The nutritional content, also referred to herein as nutritional value, of foods and beverages, as used herein, refers to the non-caloric content of these nutritional substances which are beneficial to the organisms which consume these nutritional substances. For example, the nutritional content of a nutritional substance could include vitamins, minerals, proteins, and other non-caloric components which are necessary, or at least beneficial, to the organism consuming the nutritional substances.

While there has recently been greater attention by consumer organizations, health organizations and the public to the nutritional content of foods and beverages, the food and beverage industry has been slow in responding to this attention. Today's innovation, research and scientific advances of food and Beverage industry have been primarily focused on producing more volume and preserving nutritional substances longer to supply the needs of our population. More over the industry has developed in silos increasingly adding dyes, preservatives, artificial flavors, enhancers, artificial sweeteners, pesticides, hormones, antibiotics, and other additives to fulfill this role. In particular since 1940, over 75,000 artificial chemicals have been created and many appear in food products, such as blueberry muffins, “diet” sodas.

One reason for this may be that since the food and beverage industry operates as silos of those who create nutritional substances, those who preserve and transport nutritional substances, those who transform nutritional substances, and those who finally prepare the nutritional substances for consumption by the consumer, there has been no system wide coordination or management of nutritional content. While each of these silo industries may be able to maintain or increase the nutritional content of the foods and beverages they handle, each silo industry has only limited information and control of the nutritional substances they receive, and the nutritional substances they pass along. An interactive system and data base, including user-friendly dynamic nutritional substance labeling allowing consumers, and any other member or other member of the nutritional substance supply system, to access creation and origin information for nutritional substances as well as information regarding changes in nutritional, organoleptic, or aesthetic values of nutritional substances, at any moment during the life-cycle of the nutritional substance up to the moment of consumption, would offer great value to the nutritional substance supply system.

As consumers better understand their need for nutritional substances with higher nutritional content, they will start demanding that the food and beverage industry offer products which include higher nutritional content, and/or at least information regarding nutritional content of such products. In fact, consumers are already willing to pay higher prices for higher nutritional content. This can be seen at high-end grocery stores which offer organic, minimally processed, fresh, non-adulterated nutritional substances. Further, as societies and governments seek to improve their constituents' health and lower healthcare costs, incentives and/or mandates will be given to the food and beverage industry to track, maintain, and/or increase the nutritional content of nutritional substances they handle. There will be a need, not only within each food and beverage industry silo to maintain or improve the nutritional content of their products, but an industry-wide solution to allow the management of nutritional content across the entire cycle from creation to consumption. In order to manage the nutritional content of nutritional substances across the entire cycle from creation to consumption, the nutritional substance industry will need to identify, track, measure, estimate, preserve, transform, condition, and record nutritional content for nutritional substances. Providing nutritional substances with user friendly dynamic nutritional substance labeling facilitating this type of information connectivity and access will be a key in a system capable of such functionality. Of particular importance is the measurement, estimation, and tracking of changes to the nutritional content, also referred to herein as ΔN, of a nutritional substance from creation to consumption. This ΔN information could be used, not only by the consumer in selecting particular nutritional substances to consume, but could be used by the other food and beverage industry silos, including creation, preservation, transformation, and conditioning, to make decisions on how to create, handle and process nutritional substances. Additionally, those who sell nutritional substances to consumers, such as restaurants and grocery stores, could communicate perceived qualitative values of the nutritional substance in their efforts to market and position their nutritional substance products. Further, a determinant of price of the nutritional substance could be particular nutritional, organoleptic, or aesthetic values, and if changes to those values, also referred to herein as ΔN, are perceived as desirable. For example, if a desirable value has been maintained, improved, or minimally degraded, it could be marketed as a premium product.

For example, the grower of sweet corn generally only provides basic information as the variety and grade of its corn to the packager, who preserves and ships the corn to a producer for use in a ready-to-eat dinner. The packager may only tell the producer that the corn has been frozen as loose kernels of sweet corn. The producer may only provide the consumer with rudimentary instructions how to cook or reheat the ready-to-eat dinner in a microwave oven, toaster oven or conventional oven, and only tell the consumer that the dinner contains whole kernel corn among the various items in the dinner. Finally, the consumer of the dinner will likely not express opinions on the quality of the dinner, unless it was an especially bad experience, where the consumer might contact the producer's customer support program to complain. Very minimal, or no, information on the nutritional content of the ready-to-eat dinner is passed along to the consumer. The consumer knows essentially nothing about changes (generally a degradation, but could be a maintenance or even an improvement) to the nutritional content, ΔN, of the sweet corn from creation, processing, packaging, cooking, preservation, preparation by consumer, and finally consumption by the consumer. Unfortunately, today consumers have no way to access information regarding the extent to which nutritional substances have degraded at any moment during their life-cycle, including no information regarding how a nutritional substance will degrade during conditioning. Further, they have no way to access information regarding how to condition a nutritional substance in order to achieve desired nutritional, organoleptic, or aesthetic values. An interactive system and data base including user friendly dynamic nutritional substance labeling allowing consumers to access such information for nutritional substances would offer great value to the nutritional substance supply system.

Consumers' needs are changing as consumers are demanding healthier foods, such as “organic foods.” Customers are also asking for more information about the nutritional substances they consume, such as specific characteristics' relating not only to nutritional content, but to allergens or digestive intolerances. For example, nutritional substances which contain lactose, gluten, nuts, dyes, etc. need to be avoided by certain consumers. However, the producer of the ready-to-eat dinner, in the prior example, has very little information to share other than possibly the source of the elements of the ready-to-eat dinner and its processing steps in preparing the dinner. Generally, the producer of the ready-to-eat dinner does not know the nutritional content and organoleptic state and aesthetic condition of the product after it has been reheated or cooked by the consumer, cannot predict changes to these properties, ΔN, and cannot inform a consumer of this information to enable the consumer to better meet their needs. For example, the consumer may want to know what proportion of desired organoleptic properties or values, desired nutritional content or values, or desired aesthetic properties or values of the corn in the ready-to-eat dinner remain after cooking or reheating, and the change in the desired nutritional content or values, the desired organoleptic properties or values, or the desired aesthetic properties or values, ΔN, (usually a degradation, but could be a maintenance or even improvement). There is a need to preserve, measure, estimate, store and/or transmit information regarding such nutritional, organoleptic, and aesthetic values, including changes to these values, ΔN, throughout the nutritional substance supply system. Given the opportunity and a system capable of receiving and processing real time consumer feedback and updates regarding changes in the nutritional, organoleptic, and/or aesthetic value of nutritional substances, ΔN, consumers can even play a role in updating dynamic information about the nutritional substances they have purchased and/or prepared for consumption, such that that information is available and useful to others in the nutritional substance supply system via the dynamic labeling provided with the nutritional substance.

The caloric and nutritional content information for a prepared food that is provided to the consumer is often minimal. For example, when sugar is listed in the ingredient list, the consumer may not receive any information about the source of the sugar, which can come from a variety of plants, such as sugarcane, beets, or corn, which will affect its nutritional content. Conversely, some nutritional information that is provided to consumers is so detailed, the consumer can do little with it. For example, this list of ingredients is from a nutritional label on a consumer product: Vitamins—A 355 IU 7%, E 0.8 mg 4%, K 0.5 mcg, 1%, Thiamin 0.6 mg 43%, Riboflavin 0.3 mg 20%, Niacin 6.0 mg 30%, B6 1.0 mg 52%, Foliate 31.5 mcg 8%, Pantothenic 7%; Minerals Calcium 11.6 1%, Iron 4.5 mg 25%, Phosphorus 349 mg 35%, Potassium 476 mg 14%, Sodium 58.1 mg 2%, Zinc 3.7 mg 24%, Copper 0.5 mg 26%, Manganese 0.8 mg 40%, Selenium 25.7 mcg 37%; Carbohydrate 123 g, Dietary fiber 12.1 g, Saturated fat 7.9 g, Monosaturated Fat 2.1 g, Polysaturated Fat 3.6 g, Omega 3 fatty acids 108 g, Omega 6 fatty acids 3481, Ash 2.0 g and Water 17.2 g. (%=Daily Value). There is a need for dynamic labeling of nutritional substances in order to provide information about nutritional substances in a meaningful manner. Such information needs to be presented in a manner that meets the specific needs of a particular consumer. For example, consumers with a medical condition, such as diabetes, would want to track specific information regarding nutritional values associated with sugar and other nutrients in the foods and beverages they consume, and would benefit further from knowing changes in these values or having tools to quickly indicate or estimate these changes in a retrospective, current, or prospective fashion, and even tools to report these changes, or impressions of these changes, in a real-time fashion.

If fact, each silo in the food and beverage industry already creates and tracks some information, including caloric and nutritional information, about their product internally. For example, the farmer who grew the corn knows the variety of the seed, condition of the soil, the source of the water, the fertilizers and pesticides used, and can measure the caloric and nutritional content at creation. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional content occurred, the producer can modify its processing and post-processing preservation to minimally affect nutritional content. The preparation of the nutritional substance for consumption can also degrade the nutritional content of nutritional substances. Finally, the consumer knows how she prepared the dinner, what condiments were added, and whether she did or did not enjoy it.

If there was a mechanism to share this information, the quality of the nutritional substances, including caloric and nutritional, organoleptic, and aesthetic value, could be preserved and improved. Consumers could be better informed about nutritional substances they select and consume, including the state, and changes in the state, ΔN, of the nutritional substance throughout its lifecycle from creation up to the moment of consumption. The efficiency and cost effectiveness of nutritional substances could also be improved. Feedback within the entire chain from creator to consumer could provide a closed-loop system that could improve quality (taste, appearance, and caloric and nutritional content), efficiency, value and profit. For example, in the milk supply chain, at least 10% of the milk produced is wasted due to safety margins included in product expiration dates. The use of more accurate tracking information, measured quality (including nutritional content) information, and historical environmental information could substantially reduce such waste. An interactive system and data base including dynamic nutritional substance labeling for collecting, preserving, measuring and/or tracking information about a nutritional substance in the nutritional substance supply system, would allow needed accountability. There would be nothing to hide. Unfortunately, today there is no such system or dynamic nutritional substance labeling.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as existing non-dynamic nutritional substance labeling, these current systems can provide only limited information.

Nutritional substance collectors and/or producers, such as growers (plants), ranchers (animals) or synthesizer (synthetic compounds), routinely create and collect information about their products, however, that information is generally not accessible by their customers. Even if such producers wished to provide such information to their customers, there is no current method of labeling, encoding or identifying each particular product to provide such information (even though all plants, animals and in general, nutritional substances have a natural fingerprint). While there are limited methods and systems available, they are excessively costly, time consuming, and do not trace, or provide access to, the nutritional substance organoleptic and/or nutritional state across the product's lifecycle. Current labels for such products include package labels, sticker labels and food color ink labels. These labels generally are applied to all similar products and cannot identify each particular product, only variety of products, such as apple banana, but not a particular banana.

An important issue in the creation, preservation, transformation, conditioning, and consumption of nutritional substances are the changes in nutritional, organoleptic, or aesthetic values, ΔN, that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional value (often through the use of additives or preservatives), and/or attempts to hide this loss of nutritional value from consumers.

A system allowing a consumer to share a personal nutritional substance profile, which may include a history of nutritional substances consumed and nutritional, organoleptic, or aesthetic value guidelines to be followed, with other entities, would be of great benefit. In such a system, sharing may be facilitated by granting access to such a profile that exists as a database accessible through the internet. The consumer may wish to grant access to individuals, including himself, friends, family, or society members. The consumer may wish to grant access to his nutritional substance profile to his favorite restaurant. In this way the restaurant could confirm that the nutritional substances selected by the consumer, and the preparation of these nutritional substances, is consistent with the consumer's nutritional substance profile. In a similar way, the consumer may wish to grant access to his nutritional substance profile to a supermarket or a specific Brand, or the consumer might grant access to his dietician, personal trainer, or physician. Access might be accomplished in a manner similar to accepting a friend on Facebook or a follower on Twitter, by password, or in any other suitable fashion. Access might be granted on a by device basis or by application basis, such as the consumer's smartphone or tablet computer or applications running on his smartphone or tablet computer. Access might be granted on an item by item basis, such as granting access based upon a unique nutritional substance identifier or a unique type of nutritional substance identifier provided with a nutritional substance. Such identifiers are also referred to herein as dynamic information identifiers and are discussed in subsequent sections of this specification. Further, access may be open to certain types of entities, without the need for a consumer granting access. Examples of this type of open access could include, but are not limited to, any restaurant or any supermarket.

Overall, the examples herein of some prior or related systems and their associated limitations are intended to be illustrative and not exclusive. Other limitations of existing or prior systems will become apparent to those of skill in the art upon reading the following Detailed description.

### OBJECTS OF THE INVENTION

Depending upon its embodiment, the realization of inventions described herein may obtain one or more of the below-discussed objects.

One of the realized objects of the present inventions may be to provide a communication system which collects, tracks, and organizes information from each stage of the production of nutritional substances from creation to consumption. Such information can be used to modify the creation, packaging, transformation, conditioning and consumption of nutritional substances.

Another one of the realized objects of the present inventions may be to track and estimate changes in nutritional, organoleptic, and/or aesthetic values of the nutritional substance, such changes referred to herein as ΔN changes, at any moment from creation through consumption. Such information on ΔN changes can be used in a manner that minimizes degradation and/or preserves and/or enhances the nutritional value and/or organoleptic value and/or aesthetic value of the nutritional substances across their lifecycle.

Another one of the realized objects of the present inventions may be to provide information that a communication system collects, tracks, and organizes from each stage of the production of nutritional substances from creation to consumption such that the information is openly available and openly integrated at any point in time to all constituents in the nutritional substance supply system. In a preferred embodiment, the nutritional substances are provided with dynamic labeling enabling the integration and availability of the information. In a preferred embodiment, this information becomes openly available and openly integrated as soon as it is created.

Another one of the realized objects of the present inventions may be to collect, store and provide information on the consumer of dynamically-labeled nutritional substances, including information regarding nutritional, organoleptic, and/or aesthetic values of the nutritional substance.

Another one of the realized objects of the present inventions may be to track changes and/or minimize and/or track degradation of nutritional, organoleptic, and/or aesthetic value of dynamically-labeled nutritional substances, or ΔN, and/or collect, store, and/or transmit information regarding this degradation.

Another one of the realized objects of the present inventions may be to provide all constituents in the nutritional supply system, including the final consumer, with dynamic information about a current or estimated state of nutritional, organoleptic, and/or aesthetic value, and/or changes to such value (ΔN). It is a further object of the present invention to provide consumers with the tools to verify ΔN, along with other source or nutritional substance attributes of interest, prior to and/or during and/or after purchase and prior to and/or after preparation and prior to consumption.

Another one of the realized objects of the present inventions may be to provide nutritional substance creators, preservers, packagers, transformers, and conditioners the ability to dynamically update nutritional substance labeling content in a manner that makes the updated content available for consumers upon update. In other words, the labeling content, and any updates to the labeling content, are available upon update by nutritional substance creators, preservers, packagers, transformers, and conditioners. For example, an update in labeling content for the beans used in a can of soup would immediately be available to consumers shopping in a grocery store, consumers and restaurants preparing a meal, transformers manufacturing a frozen meal using the beans, and so on. In a preferred embodiment, such labeling content and updates to labeling content are facilitated by dynamic labeling provided with a nutritional substance.

Another one of the realized objects of the present inventions may be to provide a nutritional substance information system allowing a consumer to share a personal nutritional substance profile, which may include a history of nutritional substances consumed and nutritional, organoleptic, or aesthetic value guidelines to be followed, with other entities. In such a system, sharing may be facilitated by granting access to such a profile that exists as a database accessible through the internet. The consumer may wish to grant access to individuals, including himself, friends, family, society members, particular restaurants, particular supermarkets, particular brands, a dietician, physician, personal trainer, or any other entity or group as desired. In this way other entities could confirm that nutritional substances selected by the consumer, and the preparation of these nutritional substances, are consistent with the consumer's nutritional substance profile.

Another one of the realized objects of the present inventions may be that access to a personal nutritional substance profile can be granted on a by device basis or by application basis, such as the consumer's smartphone or tablet computer or applications running on his smartphone or tablet computer. Such access can be granted on an item by item basis, such as granting access based upon a unique nutritional substance identifier, also referred to herein as a dynamic information identifier, or a unique type of nutritional substance identifier provided through dynamic labeling of a nutritional substance. Such access can be open to certain types of entities, without the need for a consumer granting access. Examples of this type of open access could include, but are not limited to, access to any restaurant or access to any supermarket.

Another one of the realized objects of the present inventions may be to integrate a consumer's genetic footprint with his nutritional needs. Data regarding the consumer's genetic footprint could be used to develop a personal nutritional substance profile recommended for the consumer based upon the genetic footprint. The personal nutritional substance profile would be prescriptive or anticipatory in nature and would optimize criteria such as quality of life, life expectancy, physical strength, mental capabilities, or other desired criteria. The information collected on consumer populations utilizing such a nutritional substance consumer information module could be benchmarked or compared to similar populations not benefiting from such a personal nutritional substance profile.

Another one of the realized objects of the present inventions may be to make available different types of information and different presentation and interface architecture depending on the target user, in order that the target user can effectively and efficiently utilize the available information. For example, the type of information, presentation and interface architecture provided for professionals may be different than that provided for consumers. The type of information, presentation and interface architecture provided for different professional disciplines may differ from one another. In this way, unique types of information and different presentation and interface architecture could be provided for consumers, buyers, chefs, physicians, personal trainers, dieticians, regulators, societies, creators, preservers, transformers, and conditioners.

Another one of the realized objects of the present inventions may be to provide a nutritional substance information system that facilitates professional to professional communication as well as professional to consumer communication regarding source, origin, and creation information for nutritional substances and information regarding changes in nutritional, organoleptic, or aesthetic values of nutritional substances and information regarding a current state of a nutritional, organoleptic, or aesthetic value of nutritional substances.

Another one of the realized objects of the present inventions may be to provide a nutritional substance information system that facilitates input from academic, scientific, and public health organizations form around the world regarding source, origin, and creation information for nutritional substances and information regarding changes in nutritional, organoleptic, or aesthetic values of nutritional substances and information regarding a current state of a nutritional, organoleptic, or aesthetic value of nutritional substances.

### SUMMARY OF THE INVENTION

Other advantages and features of the present inventions will become apparent from the following description and claims. It should be understood that the description and specific examples are intended for purposes of illustration only and not intended to limit the scope of the present disclosure.

In one embodiment of the present inventions, information relating to the creation/origin of a nutritional substance is traceable to any precedent or subsequent user or consumer of that nutritional substance. Similarly, information regarding the packaging of a nutritional substance is also passed to precedent and subsequent users and/or consumers of the nutritional substance. Additionally, information regarding the transformation of a nutritional substance is passed along providing access to experts, professionals and the consumer of the nutritional substance and can be used to make nutritional substance selection as well as to modify nutritional substance preparation, trace its origin, determine a ΔN, and/or determine a state of nutritional, organoleptic, and/or aesthetic value throughout its nutritional substance industry cycle and provide access to information related to the nutritional substance stored in a nutritional substance information database or generated in real time across the globe.

In another embodiment of the present invention, such information could include observed or measured information reported by a consumer.

In another embodiment of the present invention, such information could include observed or measured or newly revised information from a creator, preserver, transformer, or conditioner.

In another embodiment of the present invention, such information could be mapped out regarding the creation, packaging, transformation, conditioning, and consumption of the nutritional substance and is used by a subsequent user or consumer of the nutritional substance to modify their use, preservation, transformation and/or conditioning of the nutritional substance.

In another embodiment of the present invention, such information could be mapped out regarding the creation, packaging, transformation, and conditioning of the nutritional substance to be used by a consumer of the nutritional substance to confirm that their intended use, preservation, transformation and/or conditioning of the nutritional substance will result in a nutritional substance that meets their needs, particularly as it relates to a ΔN of the nutritional substance. This eliminates the risks currently faced by consumers associated with having no way of determining such information, and additionally eliminates the liability currently faced by creators, preservers, transformers, and conditioners by not making such information available to consumers.

In another embodiment of the present invention a communication system collects, tracks, and organizes information from each stage of the production of nutritional substances from creation to consumption such that the information is openly available and openly integrated at any point in time to all constituents in the nutritional substance supply system. In a preferred embodiment, the nutritional substances are provided with dynamic labeling enabling the integration and availability of the information. In a preferred embodiment, the information is integrated and available as soon as it is created.

In another embodiment of the present invention, the information collected by the creator, packager, transformer, conditioner and consumer of dynamically labeled nutritional substances is stored in a multi-dimensional database for analysis. Additionally, such information is transmitted to the creators, packagers, transformers, conditioners and consumers for improvement of the nutritional substance and for process improvement. The transmission of such information can be accomplished using any form of telecommunication, including the internet and wireless communication.

In another embodiment of the present invention, the information collected by the creator, packager, transformer, conditioner and consumer of dynamically labeled nutritional substances includes observed or measured information reported by a consumer which is stored in a multi-dimensional database for analysis. Additionally, such information is transmitted to the creators, packager, transformers, conditioners and consumers of the nutritional substances. The transmission of such information can be accomplished using any form of telecommunication, including the internet and wireless communication.

In the preferred embodiment of the present invention, a communication system uses information regarding the consumer of dynamically labeled nutritional substances to dynamically modify the creation, preservation, transformation, conditioning and selection of nutritional substances to meet the consumer's needs.

In an embodiment of the present invention, information regarding the consumer is used dynamically within a communication system to alert the consumer of dynamically labeled nutritional substances that a selection of a nutritional substance does not meet the consumer's needs or is not consistent with the information regarding the consumer.

A further embodiment of the present invention is to provide a system allowing a consumer to share a personal nutritional substance profile, which may include a history of nutritional substances consumed and nutritional, organoleptic, or aesthetic value guidelines to be followed, with other entities. Sharing may be facilitated by granting access to such a profile wherein the profile exists as a database accessible through the internet. The consumer may grant access to individuals, including himself, friends, family, or society members. The consumer may grant access to his nutritional substance profile to his favorite restaurant. In this way the restaurant can confirm that the nutritional substances selected by the consumer, and the preparation of these nutritional substances, is consistent with the consumer's nutritional substance profile. In a similar way, the consumer may grant access to his nutritional substance profile to a supermarket or a specific Brand, or the consumer might grant access to his dietician, personal trainer, or physician. Access might be accomplished in a manner similar to accepting a friend on Facebook or a follower on Twitter, by password, or in any other suitable fashion. Access might be granted on a by device basis or on an application basis, such as the consumer's smartphone or tablet computer or applications running on his smartphone or tablet computer or a conditioner or conditioning module for conditioning nutritional substances. Access might be granted on an item by item basis, such as granting access based upon a unique nutritional substance identifier or a unique type of nutritional substance identifier provided with a nutritional substance. Such identifiers are also referred to herein as dynamic information identifiers, comprising at least a portion of the dynamic labeling of dynamically-labeled nutritional substances, and are discussed in subsequent sections of this specification. Further, access may be open to certain types of entities, without the need for a consumer granting access. Examples of this type of open access could include, but are not limited to, any restaurant or any supermarket.

A further embodiment of the present invention is to provide a nutritional substance consumer information module that integrates the consumer's genetic footprint with his nutritional needs. Such a nutritional substance consumer information module would have access to data regarding the consumer's genetic footprint and develop a personal nutritional substance profile recommended for the consumer based upon the genetic footprint. Such a personal nutritional substance profile would be prescriptive or anticipatory in nature and could be developed to optimize any of the consumer's quality of life, life expectancy, physical strength, mental capabilities, or other desired optimization criteria. Further, information collected on consumer populations utilizing such a nutritional substance consumer information module could be benchmarked or compared to similar populations not utilizing such a nutritional substance consumer information module.

In an embodiment of the present invention different types of information and different presentation and interface architecture are made available to different types of target users, in order that a target user can effectively and efficiently utilize the available information. The type of information, presentation and interface architecture provided for professionals may be different than that provided for consumers. The type of information, presentation and interface architecture provided for different professional disciplines may differ from one another. Unique types of information and different presentation and interface architecture could be provided for consumers, buyers, chefs, physicians, personal trainers, dieticians, regulators, societies, creators, preservers, transformers, and conditioners.

In an embodiment of the present invention a nutritional substance information system is provided that facilitates professional to professional communication as well as professional to consumer communication regarding source, origin, and creation information for nutritional substances and information regarding changes in nutritional, organoleptic, or aesthetic values of nutritional substances and information regarding a current state of a nutritional, organoleptic, or aesthetic value of nutritional substances.

In an embodiment of the present invention a nutritional substance information system is provided that facilitates input from academic, scientific, and public health organizations form around the world regarding source, origin, and creation information for nutritional substances and information regarding changes in nutritional, organoleptic, or aesthetic values of nutritional substances and information regarding a current state of a nutritional, organoleptic, or aesthetic value of nutritional substances

An embodiment of the present invention provides a system for the creation, collection, storage, transmission, and/or processing of information regarding dynamically labeled nutritional substances so as to improve, maintain, or minimize degradation of nutritional, organoleptic, and/or aesthetic value of the nutritional substances. Additionally, the present invention provides such information for use by the creators, preservers, transformers, conditioners, and consumers of nutritional substances. It is a preferred that this information is openly available and openly integrated at any point in time to all constituents in the nutritional substance supply system. It is preferred that dynamic labeling provided with the nutritional substances enables the integration and availability of the information and that this information becomes openly available and openly integrated as soon as it is created. The nutritional information creation, preservation, and transmission system of the present invention should allow the nutritional substance supply system to improve its ability to minimize degradation of nutritional, organoleptic and/or aesthetic value of the nutritional substance, and/or inform the consumer, creator, packager, transformer, or conditioner about such degradation, or ΔN. While the ultimate goal of the nutritional substance supply system is to minimize degradation of nutritional, organoleptic and/or aesthetic values, or as it relates to ΔN, minimize the negative magnitude of ΔN. However, an interim goal should be providing consumers with significant information regarding any change, particularly degradation, of nutritional, organoleptic and/or aesthetic values of nutritional substances, and/or component nutritional substances thereof, consumers select and consumer, the ΔN, such that desired information regarding specific residual nutritional, organoleptic, and/or aesthetic values can be ascertained using the ΔN. Entities within the nutritional substance supply system that provide such ΔN information regarding nutritional substances, particularly regarding degradation, will be able to differentiate their products from those who obscure and/or hide such information. Additionally, such entities should be able to charge a premium for products which either maintain their nutritional, organoleptic, and/or aesthetic value, or supply more complete information about changes in their nutritional, organoleptic, and/or aesthetic value, the ΔN. Further, entities that supply conditioning equipment and other devices enabling consumer access and utilization of ΔN information will be able to differentiate their products from those that do not enable the consumer to access and utilize ΔN information. Such conditioning equipment will allow consumers to minimize degradation of, preserve, or improve the nutritional, organoleptic, and/or aesthetic value of the nutritional substances they consume. Such conditioners will further enable the consumer to optimize the nutritional, organoleptic, and/or aesthetic value of the nutritional substances they condition and consume according to their individual needs or desires. Such individual needs or desires may exist in part or whole as a personal nutritional substance profile for the consumer.

In an embodiment of the present invention, observed or measured ΔN information regarding dynamically-labeled nutritional substances can also be provided by consumers, so that it can be received and reflected through reporting or modification of a nutritional substance database. In this way, consumer reports regarding observed or measured changes in nutritional, organoleptic, and/or aesthetic values of dynamically-labeled nutritional substances they have purchased, are going to prepare, or are going to consume, are in some way incorporated into a nutritional substance database.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a nutritional substance supply relating to the present invention;

FIG. 2 shows a graph representing a value of a nutritional substance which changes according to a change of condition for the nutritional substance;

FIG. 3 shows a schematic functional block diagram of a nutritional substance supply relating to an alternate embodiment of the present invention; and

FIG. 4 shows a schematic functional block diagram of a nutritional substance supply relating to an alternate embodiment of the present invention.

FIG. 5 shows a schematic of an information module relating to an embodiment of the present invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF PREFERRED EMBODIMENTS

All references cited herein are incorporated by reference in their entirety as though fully set forth. One skilled in the art will recognize many methods and materials similar or equivalent to those described herein, which could be used in the practice of the present invention. Indeed, the present invention is in no way limited to the methods and materials described.

The various methods and techniques described below provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

In the following, among other embodiments, there will be described a system for providing particular information regarding nutritional substances, the system comprising: a first database that collects particular information for nutritional substances, wherein the particular information is collected from at least two or more of a creator, preserver, transformer, conditioner, and consumer; a second database that collects at least one of an initial nutritional and organoleptic value, as well as at least one ΔN value for the nutritional substances; source information for the nutritional substance; and means for providing ΔN values for the nutritional substances responsive to requests. Also, there is described a method of providing dynamic labeling content for a nutritional substance comprising: assigning a dynamic information identifier to a nutritional substance having at least one of non-static nutritional and organoleptic values; transmitting values referenced to said dynamic information identifier and corresponding to at least one of an initial nutritional and organoleptic value of the nutritional substance, estimating changes to said non-static nutritional or organoleptic values of the nutritional substance; and, responsive to a request referenced to said dynamic information identifier, transmitting the estimated values of said estimated changes for essentially providing dynamic labeling content for the nutritional substance.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

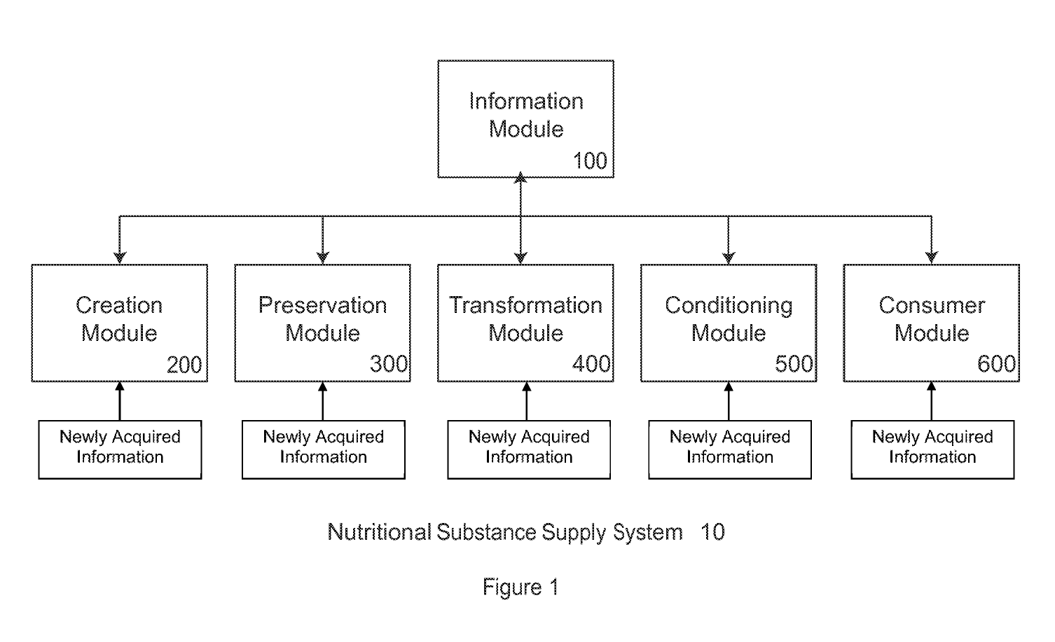

FIG. 1 shows the components of a nutritional substance industry 10. It should be understood that this could be the food and beverage ecosystem for human consumption, but could also be the feed industry for animal consumption, such as the pet food industry. A goal of the present invention for nutritional substance industry 10 is to create, preserve, transform and trace change in nutritional, organoleptic and/or aesthetic values of nutritional substances, collectively and individually also referred to herein as ΔN, through their creation, preservation, transformation, conditioning and consumption. While the nutritional substance industry 10 can be composed of many companies or businesses, it can also be integrated into combinations of business serving many roles, or can be one business or even individual. Since ΔN is a measure of the change in a value of a nutritional substance, knowledge of a prior value (or state) of a nutritional substance and the ΔN value will provide knowledge of the changed value (or state) of a nutritional substance, and can further provide the ability to estimate a change in value (or state).

Module 200 is the creation module. This can be a system, organization, or individual which creates and/or originates nutritional substances. Examples of this module include a farm which grows produce; a ranch which raises beef; an aquaculture farm for growing shrimp; a factory that synthesizes nutritional compounds; a collector of wild truffles; or a deep sea crab trawler.

Preservation module 300 is a preservation system for preserving and protecting the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actually can be placed anywhere nutritional substances need to be preserved during their transition from creation to consumption.

Transformation module 400 is a nutritional substance processing system, such as a manufacturer who processes raw materials such as grains into breakfast cereals. Transformation module 400 could also be a ready-to-eat dinner manufacturer who receives the components, or ingredients, also referred to herein as component nutritional substances, for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substance for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

Consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow.

Information module 100 receives and transmits information regarding dynamically labeled nutritional substances between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. It is preferred that the information module 100 collects, tracks, and organizes information regarding the dynamically-labeled nutritional substances from each stage of the production of the nutritional substances from creation to consumption and that the information regarding the dynamically-labeled nutritional substances is openly available and openly integrated at any point in time to all modules of the nutritional substance supply system, preferably as soon as it is created. The integration and availability of the information is enabled by dynamic labeling provided with the nutritional substances, which includes a unique nutritional substance identifier, also referred to herein as a dynamic information identifier. Information module 100 contains a database, also referred to herein as a dynamic nutritional value database, where the information regarding the dynamically labeled nutritional substance resides and can be referenced or located by the corresponding dynamic information identifier. Information module 100 can be connected to the other modules by a variety of communication systems, such as paper, computer networks, the Internet and telecommunication systems, such as wireless telecommunication systems. In a system capable of receiving and processing real time consumer feedback and updates regarding changes in the nutritional, organoleptic, and/or aesthetic value of dynamically-labeled nutritional substances, or ΔN, consumers can even play a role in updating a dynamic nutritional value database with observed or measured information about the dynamically-labeled_nutritional substances they have purchased and/or prepared for consumption, so that the information is available and useful to others in the nutritional substance supply system, such as through reports reflecting the consumer input or through modification of ΔN. In a system capable of receiving and processing creator, preserver, transformer, or conditioner updates regarding a ΔN or other attribute of dynamically-labeled nutritional substances they have created or processed, the creator, preserver, transformer, or conditioner can play a role in revising a dynamic nutritional value database with observed or measured or newly acquired information about the dynamically-labeled nutritional substances they have previously created or processed, so that the revised information is available and useful to others in the nutritional substance supply system, such as through reports reflecting such input or through modification of ΔN.

At this juncture it can be understood that an organic or aesthetic value of a nutritional substance can include its olfactory values. Typically, but not necessarily, olfactory values are detectable by the human sense of smell. However, nutritional substance may emit or produce gaseous components that are not detectable or discernable by the human sense of smell but, nevertheless, may be indicative of particular state of the nutritional substance. In addition, olfactory values can be indicative of contamination or adulteration of nutritional substances by other substances.

As will be appreciated upon consideration of the description herein, the method of providing dynamic labeling content for a nutritional substance can include steps for gathering and providing information regarding adulteration of the nutritional substance. Information regarding adulteration of nutritional substances can come from various sources, not just detection of olfactory values as mentioned above.

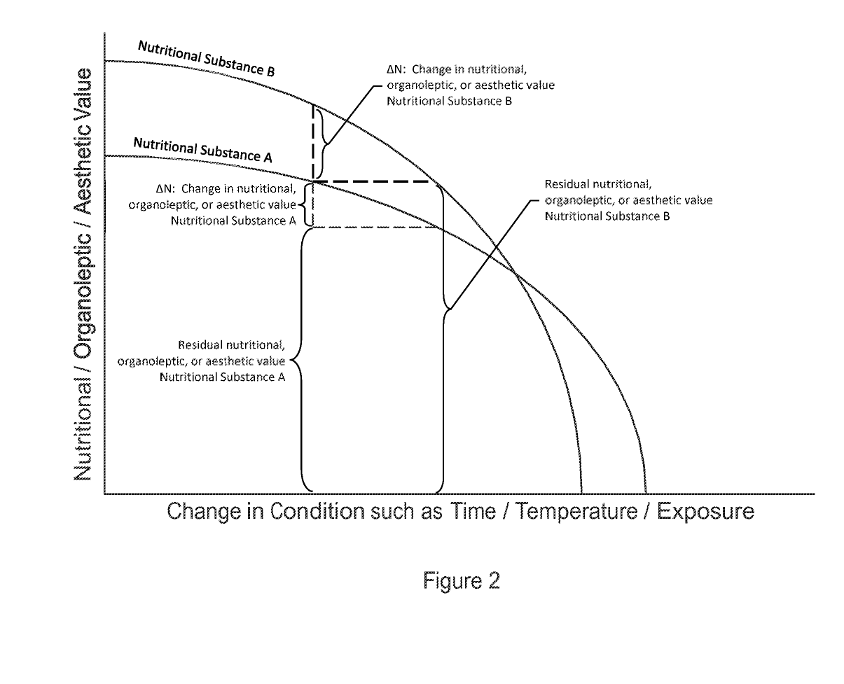

FIG. 2 is a graph showing the function of how a nutritional, organoleptic, or aesthetic value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of the nutritional substance, ΔN, over a variable such as time, temperature, location, and/or exposure to environmental conditions (this is indicated as “ΔN: Change in nutritional, organoleptic, or aesthetic value” in FIG. 2) Also shown in FIG. 2 is the residual nutritional, organoleptic, or aesthetic value of the nutritional substance (indicated by “Residual nutritional, organoleptic, or aesthetic value”). This exposure to environmental conditions can include: exposure to air, including the air pressure and partial pressures of oxygen, carbon dioxide, water, or ozone; airborne chemicals, pollutants, allergens, dust, smoke, carcinogens, radioactive isotopes, or combustion byproducts; exposure to moisture; exposure to energy such as mechanical impact, mechanical vibration, irradiation, heat, or sunlight; or exposure to materials such as packaging. The function plotted as nutritional substance A could show a ΔN for milk, such as the degradation of a nutritional value of milk over time. Any point on this curve can be compared to another point to measure and/or describe the change in nutritional value, or the ΔN of nutritional substance A. The plot of the degradation in the same nutritional value of nutritional substance B, also milk, describes the change in nutritional value, or the ΔN of nutritional substance B, a nutritional substance which starts out with a higher nutritional value than nutritional substance A, but degrades over time more quickly than nutritional substance A.

In this example, where nutritional substance A and nutritional substance B are milk, this ΔN information regarding the nutritional substance degradation profile of each milk could be used by the consumer in the selection and/or consumption of the milk if nutritional substance A and nutritional substance B are provided with dynamic labeling, which would include a dynamic information identifier for each nutritional substance. Using the dynamic information identifier obtained from the dynamic labeling provided with each nutritional substance, the consumer could retrieve desired ΔN information, such as the nutritional substance degradation profile referenced to each of the milks, from a dynamic nutritional value database. If the consumer has this information at time zero when selecting a milk product for purchase, the consumer could consider when the consumer plans to consume the milk, whether that is on one occasion or multiple occasions. For example, if the consumer planned to consume the milk prior to the point when the curve represented by nutritional substance B crosses the curve represented by nutritional substance A, then the consumer should choose the milk represented by nutritional substance B because it has a higher nutritional value until it crosses the curve represented by nutritional substance A. However, if the consumer expects to consume at least some of the milk at a point in time after the time when the curve represented by nutritional substance B crosses the curve represented by nutritional substance A, then the consumer might choose to select the milk represented by the nutritional substance A, even though milk represented by nutritional substance A has a lower nutritional value than the milk represented by nutritional substance B at an earlier time. This change to a desired nutritional value in a nutritional substance, ΔN, over a change in a condition of the nutritional substance described in FIG. 2 can be measured and controlled throughout nutritional substance supply system 10 in FIG. 1. This example demonstrates how dynamically generated information regarding a ΔN of a dynamically labeled nutritional substance, in this case a change in nutritional value of milk, can be used to understand a rate at which that nutritional value changes or degrades; when that nutritional value expires; and a residual nutritional value of the nutritional substance over a change in a condition of the nutritional substance, in this example a change in time. This ΔN information could further be used to determine a best consumption date for nutritional substance A and B, which could be different from each other depending upon the dynamically generated information generated for each.

There is also the ΔN as two or more nutritional substances combine. For example, when lemon is added to guacamole it keeps the avocado in the guacamole from turning black. The function plotted as nutritional substance A could show a ΔN for guacamole made by a first transformer, such as the degradation of an aesthetic value of guacamole over time, in this case a degradation of its green color. Any point on this curve can be compared to another point to measure and/or describe the change in aesthetic value, or the ΔN of nutritional substance A. The plot of the degradation in the same aesthetic value of nutritional substance B, a guacamole made by a second transformer, describes the change in the same aesthetic value, or the ΔN, of nutritional substance B. Nutritional substance B starts out with a higher aesthetic value than nutritional substance A, but degrades over time more quickly than nutritional substance A, for instance because the transformer of nutritional substance B adds less lemon juice to their guacamole in order not to distract from the flavor of the avocado. The information available is related to the interaction of the avocado and lemon juice in the respective manufacturer's guacamole, and can enable the consumer to make decisions related to the aesthetic value of the guacamole at a given point in time if nutritional substance A and nutritional substance B are provided with dynamic labeling, which would include a dynamic information identifier for each nutritional substance. Using the dynamic information identifier obtained from the dynamic labeling provided with each nutritional substance, the consumer could retrieve desired ΔN information, such as the aesthetic degradation profile referenced to each guacamole, from a dynamic nutritional value database. For example, if the consumer is purchasing the guacamole to consume at a time before the two curves intersect, and the decision is based on superior aesthetic value, the consumer will choose nutritional substance B. If the consumer is purchasing the guacamole to consume after the time the two curves intersect, and the decision is based on superior aesthetic value, the consumer will choose nutritional substance A, even though it has lower aesthetic value at the time of purchase.

In another example, the lemon has been added to sliced apples to keep the sliced apples from turning black. The function plotted as nutritional substance A could show a ΔN for sliced apples transformed by a first transformer, such as the degradation of the aesthetic value of the sliced apples over time, in this case a degradation of its pale color. Any point on this curve can be compared to another point to measure and/or describe the change in aesthetic value, or the ΔN of nutritional substance A. The plot of the degradation in the same aesthetic value of nutritional substance B, sliced apples made by a slightly different process by a second transformer, describes the same change in the aesthetic value, or the ΔN, of nutritional substance B. Nutritional substance B starts out with a higher aesthetic value than nutritional substance A, but degrades over time more quickly than nutritional substance A, for instance because the manufacturer of nutritional substance B adds less lemon juice to their sliced apples in order not to distract from the flavor of the apples. The information available is related to the interaction of the apples and lemon juice in the respective transformer's sliced apples, and can enable the consumer to make decisions related to the aesthetic value of the sliced apples at a given point in time if nutritional substance A and nutritional substance B are provided with dynamic labeling, which would include a dynamic information identifier for each nutritional substance. Using the dynamic information identifier obtained from the dynamic labeling provided with each nutritional substance, the consumer could retrieve desired ΔN information, such as the aesthetic degradation profile referenced to the sliced apples of each transformer, from a dynamic nutritional value database. For example, if the consumer is purchasing the sliced apples to consume before the time the two curves intersect, and the decision is based on superior aesthetic value, the consumer will choose nutritional substance B. If the consumer is purchasing the sliced apples to consume after the time the two curves intersect, and the decision is based on superior aesthetic value, the consumer will choose nutritional substance A, even though it has lower aesthetic value at the time of purchase.

In FIG. 1, Creation module 200 can dynamically encode nutritional substances, as part of the nutritional substance dynamic labeling, to enable the tracking of changes in nutritional, organoleptic, and/or aesthetic value of the nutritional substance, or ΔN. This dynamic encoding, also referred to herein as a dynamic information identifier, can replace and/or complement existing nutritional substance marking systems such as barcodes, labels, and/or ink markings. This dynamic encoding, or dynamic information identifier, can be used to make nutritional substance information from creation module 200 available to information module 100 for use by preservation module 300, transformation module 400, conditioning module 500, and/or consumption module 600, which includes the ultimate consumer of the nutritional substance. A key resource also available through module 100 is recipe information regarding meals that may utilize the nutritional substances as components. The ΔN information combined with recipe information from module 100 will not only be of great benefit to the consumer in understanding and accomplishing the nutritional, organoleptic, and aesthetic values desired, it will even help dispel misunderstandings that consumers may have about particular nutritional, organoleptic, and aesthetic values of nutritional substances or the combination or nutritional substances. One method of providing dynamically labeled nutritional substances with a dynamic information identifier by creation module 200, or any other module in nutritional supply system 10, could include an electronic tagging system, such as the tagging system manufactured by Kovio of San Jose, Calif., USA. Such thin film chips can be used not only for tracking nutritional substances, but can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow the dynamic nutritional value database of information module 100 real time, or near real time updates about a ΔN of a particular nutritional substance. In turn, this information is openly available and openly integrated at any point in time to all constituents in the nutritional substance supply system. It is also preferred that this information becomes openly available and openly integrated as soon as it becomes available.

A method of marking a dynamically-labeled nutritional substance with a dynamic information identifier, by creation module 200, or any other module in nutritional supply system 10, could include providing an actual printed alphanumeric code on the nutritional substance that can be scanned, such as by a smartphone with a camera running an application for reading alphanumeric characters, or might be manually entered by any member of the nutritional substance supply system. Another method of marking a dynamically-labeled nutritional substance with a dynamic information identifier by creation module 200 or any other module in nutritional supply system 10, could include providing the nutritional substance with a barcode allowing retrieval of the dynamic information identifier using an appropriate barcode scanner, such as a smartphone with a camera running an application for reading barcode. Another method of marking a dynamically-labeled nutritional substance with a dynamic information identifier, by creation module 200, or any other module in nutritional supply system 10, could include providing the nutritional substance with an RF tag allowing retrieval of the dynamic information identifier using an appropriate RF scanner. Still another method of marking a dynamically-labeled nutritional substance with a dynamic information identifier, by creation module 200, or any other module in nutritional supply system 10, could include providing the nutritional substance with a printed QR code (Quick Response Code) allowing retrieval of the dynamic information identifier using an appropriate QR code scanner, such as a smartphone with a camera running an application for reading QR code.

QR codes offer several advantages over other marking methodologies. QR codes are currently utilized by many consumers, using their smartphones, to hardlink to a target website through a URL (Uniform Resource Locator) stored on the QR code. This type of hardlinking is also known as object hyperlinking QR codes are simple to generate, inexpensive printed labels with sufficient storage capacity to store a dynamic information identifier and to store a URL to information module 100. QR codes can be provided on nutritional substances, by any member of the nutritional substance supply system, to include the nutritional substance dynamic information identifier and a URL to link any member of the nutritional substance supply system to information module 100. Using a smart phone any member of the nutritional substance supply system can scan a nutritional substance dynamically labeled with QR code to obtain a dynamic information identifier and automatically be linked to information module 100 to retrieve creation, origin, and ΔN information referenced to the scanned nutritional substance. QR codes are a cost effective, readily adopted, provider-friendly, and user-friendly way to mark nutritional substances according to the present invention.

Preservation module 300 includes packers and shippers of nutritional substances. The tracking of changes in nutritional, organoleptic, and/or aesthetic values, or a ΔN, during the preservation period within preservation module 300 allows for dynamic expiration dates for nutritional substances. For example, expiration dates for dairy products are currently based generally only on time using assumptions regarding minimal conditions at which dairy products are maintained. This extrapolated expiration date is based on a worst-case scenario for when the product becomes unsafe to consume during the preservation period. In reality, the degradation of dairy products may be significantly less than this worst-case. If preservation module 300 could measure or derive the actual degradation information such as ΔN, an actual expiration date, referred to herein as a dynamic expiration date, can be determined dynamically, and could be significantly later in time than an extrapolated expiration date. This would allow the nutritional substance supply system to dispose of fewer products due to expiration dates. This ability to dynamically generate expiration dates for nutritional substances is of particular significance when nutritional substances contain few or no preservatives. Such products are highly valued throughout nutritional substance supply system 10, including consumers who are willing to pay a premium for nutritional substances with few or no preservatives. Consumers of nutritional substances provided with dynamic labeling comprising dynamic information identifiers according to the present invention could readily access information regarding dynamic expiration dates for the nutritional substances.

It should be noted that a dynamic expiration date need not be indicated numerically (i.e., as a numerical date) but could be indicated symbolically as by the use of colors—such as green, yellow and red employed on semaphores—or other designations. In those instances, the dynamic expiration date would not be interpreted literally but, rather, as a dynamically-determined advisory date. In practice a dynamic expiration date will be provided for at least one component of a single or multi-component nutritional substance. For multi-component nutritional substances, the dynamic expiration date could be interpreted as a “best” date for consumption for particular components. Consumers of nutritional substances provided with dynamic labeling comprising dynamic information identifiers according to the present invention could readily access this type of information regarding dynamic expiration dates for the nutritional substances.

By law, in many localities, food processors such as those in transformation module 400 are required to provide nutritional substance information regarding their products. Often, this information takes the form of a nutritional table applied to the packaging of the nutritional substance. Currently, the information in this nutritional table is based on averages or minimums for their typical product. Using the nutritional substance information from information module 100 provided by creation module 200, preservation module 300, and/or information from the transformation of the nutritional substance by transformation module 400, the food processor could include a dynamically generated nutritional value table, also referred to herein as a dynamic nutritional value table, for the actual dynamically-labeled nutritional substance being supplied. The information in such a dynamic nutritional value table could be used by conditioning module 500 in the preparation of the dynamically-labeled nutritional substance, and/or used by consumption module 600, so as to allow the ultimate consumer the ability to select the most desirable dynamically-labeled nutritional substance which meets their needs, and/or to track information regarding dynamically-labeled nutritional substances consumed.

Information about changes in nutritional, organoleptic, and/or aesthetic values of nutritional substances, or ΔN, is particularly useful in the conditioning module 500 of the present invention, as it allows knowing, or estimating, the pre-conditioning state of the nutritional, organoleptic, and/or aesthetic values of the dynamically labeled nutritional substance, and allows for estimation of a ΔN associated with proposed conditioning parameters. The conditioning module 500 can therefore create conditioning parameters, such as by modifying existing or baseline conditioning parameters, which can exist as recipes and conditioning protocols available through the information module 100 or locally available through the conditioning module 500, to deliver desired nutritional, organoleptic, and/or aesthetic values after conditioning. The pre-conditioning state of the nutritional, organoleptic, and/or aesthetic value of a nutritional substance is not tracked or provided to the consumer by existing conditioners, nor is the ΔN expected from a proposed conditioning tracked or provided to the consumer either before or after conditioning. However, using information provided by information module 100 from creation module 200, preservation module 300, transformation module 400, and/or information measured or generated by conditioning module 500 and/or consumer information from the consumer module 600, conditioning module 500 could provide the consumer with the actual, and/or estimated change in nutritional, organoleptic, and/or aesthetic values of a dynamically-labeled nutritional substance, or ΔN. Further, consumer feedback and updates regarding observed or measured changes in the nutritional, organoleptic, and/or aesthetic value of dynamically-labeled nutritional substances, or ΔN, can play a role in updating a dynamic nutritional value database with information about the dynamically-labeled nutritional substances consumers have purchased and/or prepared for consumption, so that the information is available and useful to others in the nutritional substance supply system, such as through reports reflecting the consumer input or through modification of ΔN. Such information regarding the change to nutritional, organoleptic and/or aesthetic value of the dynamically-labeled nutritional substance, or ΔN, could be provided not only to the consumer, but could also be provided to information module 100 for use by creation module 200, preservation module 300, transformation module 400, so as to track, and possibly improve nutritional substances throughout the entire nutritional substance supply system 10.

The information regarding nutritional substances provided by information module 100 to consumption module 600 can replace or complement existing information sources such as recipe books, food databases like www.epicurious.com, and Epicurious apps. Through the use of specific information regarding a dynamically-labeled nutritional substance from information module 100, consumers can use consumption module 600 to select nutritional substances according to nutritional, organoleptic, and/or aesthetic values. This will further allow consumers to make informed decisions regarding nutritional substance additives, preservatives, genetic modifications, origins, traceability, and other nutritional substance attributes that may also be tracked through the information module 100. This information can be provided by consumption module 600 through personal computers, laptop computers, tablet computers, and/or smartphones. Software running on these devices can include dedicated computer programs, modules within general programs, and/or smartphone apps. An example of such a smartphone app regarding nutritional substances is the iOS ShopNoGMO from the Institute for Responsible Technology. This iPhone app allows consumers access to information regarding non-genetically modified organisms they may select. Additionally, consumption module 600 may provide information for the consumer to operate conditioning module 500 in such a manner as to optimize nutritional, organoleptic, and/or aesthetic values of a dynamically-labeled nutritional substance and/or component nutritional substances thereof according to the consumer's needs or preference, and/or minimize degradation of, preserve, or improve nutritional, organoleptic, and/or aesthetic value of a dynamically-labeled nutritional substance and/or component nutritional substances thereof.

Through the use of nutritional substance information available from information module 100 nutritional substance supply system 10 can track nutritional, organoleptic, and/or aesthetic value of dynamically-labeled nutritional substances. Using this information, dynamically-labeled nutritional substances travelling through nutritional substance supply system 10 can be dynamically valued and priced according to nutritional, organoleptic, and/or aesthetic values. For example, nutritional substances with longer dynamic expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity. Therefore, both the starting nutritional, organoleptic, and/or aesthetic value and the ΔN associated with those values are important factors in determining or estimating an actual, or residual, nutritional, organoleptic, and/or aesthetic value of a nutritional substance, and accordingly are important factors in establishing dynamically valued and priced nutritional substances.

During the period of implementation of the present inventions, there will be nutritional substances being marketed including those benefiting from dynamic labeling and the tracking of dynamic nutritional information such as ΔN, also referred to herein as information-enabled nutritional substances, and nutritional substances which do not benefit from dynamic labeling or the tracking of dynamic nutritional information such as ΔN, which are not information enabled and are referred to herein as dumb nutritional substances. Information-enabled nutritional substances would be available in virtual internet marketplaces, as well as traditional marketplaces. Because of information provided by information-enabled nutritional substances, entities within the nutritional substance supply system 10, including consumers, would be able to review and select information-enabled nutritional substances for purchase. It should be expected that, initially, the information-enabled nutritional substances would enjoy a higher market value and price than dumb nutritional substances. However, as information-enabled nutritional substances become more the norm, the cost savings from less waste due to degradation of information-enabled nutritional substances could lead to their price actually becoming less than dumb nutritional substances. Ultimately, an information system will evolve wherein information module 100 has the ability for creating traffic and signing on the address of users to not only facilitate the rapid adoption and utilization of better nutritional substance information according to the present invention, but also be a key source of business and revenue growth.

For example, the producer of a ready-to-eat dinner would prefer to use corn of a high nutritional, organoleptic, and/or aesthetic value in the production of its product, the ready-to-eat dinner, so as to produce a premium product of high nutritional, organoleptic, and/or aesthetic value. Depending upon the levels of the nutritional, organoleptic, and/or aesthetic values, the ready-to-eat dinner producer may be able to charge a premium price and/or differentiate its product from that of other producers. When selecting the corn to be used in the ready-to-eat dinner, the producer will seek corn of high nutritional, organoleptic, and/or aesthetic value from preservation module 300 that meets its requirements for nutritional, organoleptic, and/or aesthetic value. The packager/shipper of preservation module 300 would also be able to charge a premium for corn which has high nutritional, organoleptic, and/or aesthetic values. And finally, the packager/shipper of preservation module 300 will select corn of high nutritional, organoleptic, and/or aesthetic value from the grower of creation module 200, who will also be able to charge a premium for corn of high nutritional, organoleptic, and/or aesthetic values.

The change to nutritional, organoleptic, and/or aesthetic value for an information-enabled nutritional substance, or ΔN, tracked through nutritional substance supply system 10 through nutritional substance information from information module 100 can be preferably determined from measured information. However, some or all such nutritional substance ΔN information may be derived through measurements of environmental conditions of the nutritional substance as it travelled through nutritional substance supply system 10. Additionally, some or all of the information-enabled nutritional substance ΔN information can be derived from ΔN data of other information-enabled nutritional substances which have travelled through nutritional substance supply system 10. Information-enabled nutritional substance ΔN information can also be derived from laboratory experiments performed on other nutritional substances, which may approximate conditions and/or processes to which the actual information-enabled nutritional substance has been exposed. Further, consumer feedback and updates regarding observed or measured changes in the nutritional, organoleptic, and/or aesthetic value of information-enabled nutritional substances can play a role in updating ΔN information. Also, a creator, preserver, transformer, or conditioner may revise ΔN information, or information regarding other attributes of information-enabled nutritional substances they have previously created or processed, based upon newly acquired information affecting the ΔN or the other attributes.

For example, laboratory experiments can be performed on bananas to determine effect on or change in nutritional, organoleptic, and/or aesthetic value, or ΔN, for a variety of environmental conditions bananas may be exposed to during packaging and shipment in preservation module 300. Using this experimental data, tables and/or algorithms could be developed which would predict the level of change of nutritional, organoleptic, and/or aesthetic values, or ΔN, for a particular information-enabled banana based upon information collected regarding the environmental conditions to which the information-enabled banana was exposed during its time in preservation module 300. While the ultimate goal for nutritional substance supply system 10 would be the actual measurement of nutritional, organoleptic, and/or aesthetic values to determine ΔN, use of derived nutritional, organoleptic, and/or aesthetic values from experimental data to determine ΔN would allow improved logistics planning because it provides the ability to prospectively estimate changes to nutritional, organoleptic, and/or aesthetic values, or ΔN, and because it allows more accurate tracking of changes to nutritional, organoleptic, and/or aesthetic values, or ΔN, while technology and systems are put in place to allow actual measurement.

In FIG. 1, information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

Creation module 200 collects information regarding a particular nutritional substance, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance, and where the nutritional substance was delivered. This creation information can be delivered by creation module 200 to information module 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and corresponding initial nutritional, organoleptic, or aesthetic values of the corn and to whom the corn was delivered could also be collected. The farmer would provide such information to information module 100.

In the case where nutritional substance is beef hamburger meat, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered and if slaughtered, corresponding initial nutritional, organoleptic, or aesthetic values of the resulting products. Additionally, the rancher knows of the cow's immunization history and any medications, supplements and vaccines the cow was given, such as hormones, antibiotics and nutritional supplements. Also the rancher has all the information of the cow's milk production cycle and of the rate of growth, if it has been free range grass fed or in a confined environment and the state and method used to have it slaughtered. This creation information can be monitored in real time through a local or global access network. All such creation information would be provided by the rancher to information module 100.

In another example, the creator of a synthetic nutritional substance knows the source of the molecules used to create the nutritional substance, such as a vitamin complex. A multi-vitamin manufacturer knows the source of the ascorbic acid modules (vitamin C), the source of magnesium and the source of iron, and knows how they were processed into the multi-vitamin. Such creation information would also be accumulated and stored in a database that could be monitored in real time through a local or global access network. In various embodiments, the creation module 200 comprises information contained in the tags associated with a nutritional substance as described below.

In various embodiments, methods and systems are provided to tag the origin information in or about the nutritional substance. As used herein, “origin” refers to, for example, location of a specific farm where the nutritional substance is grown, location of a ranch from where the meats and/or poultry originated, location of a fishery from where the fish are caught or reared, location of a seafood farms from where the seafood is cultivated, countries, cities, states, zip codes, or latitude and longitudinal positions of the origins of the nutritional substances, or a combination thereof. In some embodiments, the origin information may originate from the creator of the nutritional substance (such as from a farmer, a rancher, a fishery etc.). In other embodiments, the origin information may originate from facilities that read the origin information contained in the nutritional substances, such as labs that run assays to read the molecular tags contained in the nutritional substance.

A dynamically-labeled nutritional substance is encoded with a “unique information identifier” or an “information identifier”, also referred to herein as a dynamic information identifier, which correlates the dynamically-labeled nutritional substance with information about the nutritional substance including but not limited to its origin, its nutritional value, changes in nutritional, organoleptic, and/or aesthetic value of the nutritional substance (ΔN) or combinations thereof. The information identifier may also be used to, for example, relate the encoded nutritional substance with information stored in an information module, such as a storage system. The storage system may be a computer, a computer database, the cloud or a combination thereof.

Dynamic nutritional substance labeling may include tags which comprise information about the origin of the nutritional substance. The tags do not affect taste, texture or nutritional characteristics of the nutritional substance. The tags may be any one or more of a mechanical tag, an electronic tag, a molecular tag, a chemical tag or a combination thereof.

In some embodiments, the tag comprising the origin information is a label that is human readable. In some embodiments, the label is directly attached to the nutritional substance (for example, stuck on to the nutritional substance). In other embodiments, the label may be, indirectly attached to the nutritional substance (for example, attached on a package containing the nutritional substance). The label may further include all or partial information about the nutritional content of the nutritional substance. Such labels can be made of paper, plastic, foil, cardboard, glass or other synthetic material and may be removed before consumption of the nutritional substance. The information on the label may also be stored in the Information Module 100 such as a storage system. The label may further comprise an information identifier that links/connects the information contained on the label about a nutritional substance with the information stored in a storage system (for example, a computer, a database, on the cloud or a combination thereof) about the same nutritional substance. The storage system may contain additional information associated with the nutritional substance that is not present on the label (for example, additional details of the nutritional content of the nutritional substance). In some embodiments, the nutritional information contained on the label and/or in the storage system provides the starting value for calculating the change in nutritional content (ΔN) as the nutritional substance is transported from the creator to the consumer 600, either directly or indirectly, via any one or more of the preservation system 300, transformation system 400, conditioning system 500, or a combination thereof. As the nutritional substance moves through each of the aforementioned systems, the nutritional content/value information is updated in the Information Module 100 (storage system), thus providing a ΔN value and a more accurate representation of the nutritional content in the nutritional substance. In another embodiment of the present invention, a system is provided allowing creators, preservers, transformers, conditioners, and consumers of nutritional substances to retrieve labeling content that reflects updated information about a nutritional substance, wherein the updated information is based upon information newly acquired by, or newly required of a creator, preserver, transformer, or conditioner of the nutritional substance after that creator, preserver, transformer, or conditioner has provided the nutritional substance to another entity, wherein the newly required information may be in order to comply with new or changed local, state, or national laws or regulations. Such updated information could include nutritional, organoleptic, or aesthetic values of the nutritional substance that have changed from that originally included as part of the labeling content or were not required as part of the original labeling content, and may further include information regarding the source, creation and other origin information for the nutritional substance that has changed from that originally included as part of the labeling content or were not required as part of the original labeling content. It is further understood that the label content requirements can vary depending on local, state, and national regulations, and that changes to labeling content requirements can be based upon changes to local, state, or national regulations.

As a specific example, at the time of the writing of this document, various States in the United States, as well as the United States federal government and the government of other countries are considering the requirement that food products containing genetically-engineered ingredients be labeled as such. Similar labeling requirements are being considered by certain retailers of processed food products. The labeling requirements could affect not only processed foods, but unprocessed foods such as apples, salmon, and so forth. Another example of a substance that could lead to labeling requirements is endocrine-disrupting chemicals that recent studies suggest that can lead to the formation of more and larger fat cells. For example, a study in 2012 found that triflumizole, a fungicide used on many food crops, like leafy vegetables, causes obesity in mice. Another 2012 study in the Journal Environmental Health Perspectives found that endocrine disruptors that are sometimes added to PVC plastic cause mice to grow obese and suffer liver problems—and the effect continues with descendants of those mice, generation after generation.

In a preferred embodiment a dynamic nutritional value database contains labeling content to be retrieved in various local, state, and national regions of nutritional substance distribution, and said labeling content is referenced by a dynamic information identifier provided with the nutritional substance or source information unique to the nutritional substance and provided with the nutritional substance.

Enabling technology for some aspects of the dynamic nutritional information may include digital tags from Altierre Corporation in San Jose, Calif. These tags can be affixed to the shelves in grocery stores and product racks in other retailers. The tags can be wirelessly updated to reflect changes in product prices.

In a further embodiment of the present invention, means allowing creators, preservers, transformers, conditioners, sellers and consumers of nutritional substances to retrieve labeling content that reflects updated information about a nutritional substance, wherein the updated information is based upon information newly acquired by, or newly required of, a creator, preserver, transformer, or conditioner of the nutritional substance after that creator, preserver, transformer, or conditioner has provided the nutritional substance to another entity, comprises any one or more of a communications, data processing, or computer system configurations, including: wireless devices, Internet appliances, hand-held devices (including personal digital assistants or PDAs, wearable computers, all manner of cellular or mobile phones, multi-processor systems, microprocessor-based or programmable consumer electronics, set-top boxes, network PCs, mini-computers, mainframe computers, telecommunication systems, wireless communication systems, internet, e-mail, text message, voice mail, social media, facsimile, and hard copy notice.

In a further embodiment of the present invention, means allowing creators, preservers, transformers, conditioners, or consumers of nutritional substances to retrieve labeling content that reflects updated information about a nutritional substance, wherein the updated information is based upon information newly acquired by, or newly required of, a creator, preserver, transformer, or conditioner of the nutritional substance after that creator, preserver, transformer, or conditioner has provided the nutritional substance to another entity further comprises a dynamic information identifier or source information unique to the nutritional substance.

Examples of the benefits of the above-described technology for retrieving labeling content information about a nutritional substance can be related to the correction of labeling of nutritional substances that are intentionally or unintentionally mislabeled. For instance, there was an incident in Europe in 2013 where horsemeat was mislabeled as beef. Concerns arose because some of the horsemeat contained a powerful equine painkiller, phenylbutazone that, in high doses, is known to cause a potentially fatal blood disorder, aplastic anemia, rendering bone marrow unable to produce blood cells. As a result of this mislabeling incident, and specifically because of the lack of knowledge as to which products contained adulterated horsemeat and which did not, significant quantities of products were removed from the distribution chain and needlessly wasted from consumption.

The above-described technology for retrieving labeling content information about a nutritional substance could potentially be utilized to dynamically revise labels, when information is made available from transformers or conditioners, to indicate whether or not an erstwhile beef product contains horsemeat and an adulterating substance such as phenylbutazone. Dynamic re-labeling can warn or reassure, as the case may be. As a specific example, for consumers that do not want to eat horsemeat, dynamic labeling can identify either the presence or absence of horsemeat in a nutritional substance.

Furthermore, in the context of the above-described degradation curves, the dynamic labeling and content information could the indicate the ΔN information for a meat product, with the particular degradation for beef and horsemeat indicated separately

At this juncture, it can also be understood that, even without providing dynamic label or content information, the information system can provide a platform for providing access to relevant information to consumers at almost any stage they request it. Indeed, in some embodiments of the present invention allow consumers to make informed decisions, to become aware of nutritional fraud and tampered products and, additionally, to access information on the actual ΔN nutritional, organoleptic and esthetic values of the nutritional substances that are offered for their consumption.

In addition, dynamic labeling can indicate the date on which the information about the nutritional content, or the ΔN of the nutritional substance, is current; in other words, might indicate whether the label reflects currently-available information, such as, for instance, contamination of beef by mixing with a substance containing phenylbutazone. Knowledge that label information in up-to-date can, in and of itself, be valuable information.

In another embodiment of the present invention, such information could be mapped out regarding the creation, packaging, transformation, and conditioning of the nutritional substance and is used by a subsequent user or consumer of the nutritional substance to modify their use, preservation, transformation and/or conditioning of the nutritional substance.

In another embodiment of the present invention, such information could be mapped out regarding the creation, packaging, transformation, and conditioning of the nutritional substance to be used by a consumer of the nutritional substance to confirm that their intended use, preservation, transformation and/or conditioning of the nutritional substance will result in a nutritional substance that meets their needs, particularly as it relates to a ΔN of the nutritional substance. This eliminates the risks currently faced by consumers associated with having no way of determining such information, and additionally eliminates the liability currently faced by creators, preservers, transformers, and conditioners by not making such information available to consumers.

In another embodiment of the present invention, nutritional substance information collected by the creator, packager, transformer, conditioner and consumer is stored in a multi-dimensional database for analysis. Additionally, such information is transmitted to the creators, packager, transformers, conditioners and consumers for improvement of the nutritional substance and for process improvement. The transmission of such information can be accomplished using any form of telecommunication, including the internet and wireless communication.

In another embodiment of the present invention, nutritional substance information collected by the creator, packager, transformer, conditioner and consumer includes observed or measured information reported by a consumer which is stored in a multi-dimensional database for analysis. Additionally, such information is transmitted to the creators, packager, transformers, conditioners and consumers of the nutritional substance. The transmission of such information can be accomplished using any form of telecommunication, including the internet and wireless communication.

In the preferred embodiment of the present invention, information regarding the consumer is used dynamically within the system to modify the creation, preservation, transformation, conditioning and selection of nutritional substances to meet the consumer's needs.

At this juncture, it can be appreciated that various embodiments of the present invention can be used to dynamically update nutritional content labels and other product information without the need to re-label food products or recall product for relabeling. Also, the availability of dynamically updated nutritional information can be used at the time of sale of a nutritional product, not only to assure the buyer that a purchased product contains a desired ingredient (or does not contain an undesired component) but also to provide conformational information to a seller. Thus, it should be understood that information tantamount (and equivalent) to label content information can be provided at the time of sale of a nutritional substance, whether the sale be at the retail level or at some other point in the chain of commerce.

At this juncture, it can be appreciated that various embodiments of the present invention can be used to dynamically update nutritional content labels and other product information without the need to re-label food products or recall product for relabeling. Also, the availability of dynamically updated nutritional information can be used at the time of sale of a nutritional product, not only to assure the buyer that a purchased product contains a desired ingredient (or does not contain an undesired component) but also to provide conformational information to a seller.

In further embodiments, the tags comprising the origin information may be computer readable, such as mechanical tags. Such tags include but are not limited to Quick Response (QR) tags, barcodes, infrared tags or magnetic tags. Such computer readable tags may be on, for example, a sticker, that is directly (e.g. on the skin of a pineapple) or indirectly (e.g. on a bushel of apples, wherein each apple in the bushel has the same origin and same or very similar nutrient content) associated with the nutritional substance. These tags may further contain all or partial information about the nutritional content of the nutritional substance. These tags may further comprise an information identifier that links/connects the information contained on the mechanical tag about a nutritional substance with the information stored in an Information Module 100 such as a storage system (for example, a computer, a database, on the cloud or a combination thereof) about the same nutritional substance. The storage system may contain additional information associated with the nutritional substance that is not present on the tags (for example, additional details of the nutritional content of the nutritional substance). The nutritional information contained in the mechanical tags and/or in the storage system provides starting values for calculating the change in nutritional content (ΔN) as the nutritional substance is transported from the creator to the consumer 600, either directly or indirectly, via any one or more of the preservation system 300, transformation system 400, conditioning system 500, or a combination thereof. As the nutritional substance moves through each of the aforementioned systems, the nutritional content information is updated in the Information Module 100 (storage system), thus providing a ΔN value and a more accurate representation of the nutritional content in the nutritional substance.

The mechanical tags may further encode, for example, Uniform Resource Locators (URLs) such that when scanned, the user is directed to a storage system that includes information about the nutritional substance. As described below, QR tags, barcodes, infrared tags or magnetic tags require a reader module (240) to retrieve the information stored in the tags. In some embodiments, reading of the mechanical codes such as the barcode or QR codes with a reader (for example visible light or infrared reader) may trigger a website to be launched that has information including but not limited to the nutritional content, caloric content, origin, growth conditions and the precise locations of creation of the nutritional substance. Alternately, reading of the QR codes with a reader may trigger a file to be downloaded that comprises the aforementioned information. The readers include but are not limited to scanners or WAN devices (such as smartphones).

In additional embodiments, the tags comprising origin information may be electronic tags such as radio frequency identification (RFID) tags (U.S. Pat. Nos. 8,314,701; 6,671,698; 6,182,725; 6,888,458; 7,256,699; 7,403,855). Such electronic tags may be on, for example, a sticker, that is directly (e.g. on the skin of a pineapple) or indirectly (e.g. on a bushel of apples, wherein each apple in the bushel has the same origin and same or very similar nutrient content) associated with the nutritional substance. These tags may further contain all or partial information about the nutrient content and nutritional value in the nutritional substance. These tags may further comprise an information identifier that links/connects the information contained on the mechanical tag about a nutritional substance with the information stored in a storage system (for example, a computer, a database, on the cloud or a combination thereof) about the same nutritional substance. The storage system may contain additional information associated with the nutritional substance that is not present on the tags (for example, additional details of the nutritional content of the nutritional substance). The nutritional information contained in the electronic tags and/or in the storage system provides starting values for calculating the change in nutritional content (ΔN) as the nutritional substance is transported from the creator to the consumer 600, either directly or indirectly, via any one or more of the preservation system 300, transformation system 400, conditioning system 500, or a combination thereof. As the nutritional substance moves through each of the aforementioned systems, the nutritional content information is updated in the Information Module 100 (storage system), thus providing a ΔN value and a more accurate representation of the nutritional content in the nutritional substance.

The electronic tags may further encode, for example, Uniform Resource Locators (URLs) such that when scanned, the user is directed to an Information Module (storage system) that includes information about the nutritional substance. Electronic tags require a reader module (240) to retrieve the information stored in the tags. In some embodiments, reading of the electronic tags with a reader may trigger a website to be launched that has information including but not limited to the nutritional content, caloric content, growth conditions and the precise locations of creation of the nutritional substance. Alternately, reading of the electronic tags with a reader may trigger a file to be downloaded that comprises the aforementioned information. The readers include but are not limited to scanners or WAN devices (such as smartphones).

In various embodiments, molecular tags may be used to correlate the origin of nutritional substances to their origin. For example, a unique set of genetic and epigenetic fingerprints may be used to trace the origins of nutritious substances. Such fingerprints may be naturally occurring in the nutritious substances or nutritious substances may be modified to express such fingerprints. For example, if the genome of the apple seeds in country 1 are modified to express long-term-repeat (LTR) sequence 1 and produce bushel-1 of apples and genome of apple seeds for apples grown in country 2 are modified to express LTR2 and produce bushel-2 of apples, sequencing the apples from each bushel can provide information about the origin of the apple. The LTR sequence is unique to each origin. The information about the LTR sequences associated with each bushel of apples and the associated country may be stored in a storage system such as a computer, a computer database the cloud or a combination thereof.

In some embodiments, plant based nutritional substances can be analyzed for presence or absence of naturally occurring microorganisms that live synergistically with the plant. The types and/or numbers of microorganisms may form a unique molecular fingerprint allowing correlation of a nutritional substance to its origin. Differences in environmental queues may result in distinct varied microbial presence in plants. For example, oranges from Florida may have a different microbial biome compared to those from California. Such differences may serve as signatures of origins of nutritional substances. In some embodiments, cultivation-dependent methods to detect microorganisms include but are not limited to PCR, RFLP, fatty acid profiles (FAME), and nutritional (Biolog), and may been used to characterize specific groups of plant-associated bacteria and fungi. Cultivation-independent PCR-based microorganism fingerprinting techniques to study small subunit (SSU) rRNA genes (rDNA) in the prokaryote microbial fraction may be used to study diversity, structural composition and dynamics of microbial communities associated with plants. For example, using terminal restriction length polymorphism, (T-RFLP) in a study of corn-associated bacteria, signals related to Cytophaga/Bacteroides/Flavobacterium phylum, Holophaga/Acidobacterium phylum, α-proteobacteria, β-proteobacteria and γ-proteobacteria were detected (Montesinos, E. Int Microbiol 2003 Vol 6 221-223). Similarly, microbial patterns (presence, absence, numbers and identities of microorganisms) may be used as fingerprints to correlate nutritional substances to their origins.

Expressions of various proteins in nutritional substances may also be used to correlate nutritional substances to their origins. In virtually all organisms, various stress conditions result in various genes being up- or down-regulated, resulting in a distinct protein profile (Sinclair, D. and Guarente, L., Scientific American March 2006 pp 48-57; Diller, K., Annual Review of Biomedical Engineering 2006 vol 8:403-424; Zerebecki R A, Sorte C J B (2011) PLoS ONE 6(4): e14806). In some embodiments, fruits and vegetables grown under drought conditions or nutrient-poor soil conditions may have a different protein profile compared to the same fruits and vegetables grown under drought-free and nutrient-rich soil conditions (Fu-Tai, Ni, Current Genomics 2009 Vol 10 269-280). For example, a correlation between levels of photosynthesis and transcription under stress was observed and differences in the number, type and expression levels of transcription factor families were also identified under drought and recovery between the three maize landraces (Hayano-Kanashiro, C et al., PLoS One 2009 Vol 4(10) e7531 1-19). Methods for analyzing protein expression will be known to one skilled in the art and include but are not limited to methods discussed in “Protein Methods”, 2nd Edition by Daniel M. Bollag, Michael D. Rozycki and Stuart J. Edelstein (1996) Published by Wiley Publishers or in Kingsmore, S., Nature Reviews Drug Discovery 5, 310-321 (April 2006).

The micronutrient content of a nutritional substance may vary based on conditions including but not limited to any one or more of environmental, soil, growth, water, light etc. In some embodiments, the micronutrient content in nutritional substances may be used to correlate a nutritional substance to its origin. For example, the blackberry phenolic composition and concentrations are influenced by genetics, growing conditions, and maturation and, for example, changes in growing conditions may alter changes in phenolic composition (Kaume, L. et al., J. Agric. Food Chem., 2012, 60 (23), pp 5716-5727). This may serve as a marker for associating various batches of blackberries with their origin. In another example, aloe vera comprises three main components: glucose; malic acid; and the polysaccharide acemannan, which is composed of a long chain of mannose monomers. On average, each mannose monomer ring has one acetate group attached to one of three available positions. Using nuclear magnetic resonance (NMR), the profiles of different acetate groups represent a fingerprint for aloe vera and its origin (Perks, B., Chemistry World 2007 49-52). Pure varieties of coffee beans may be distinguished according to profiles of analytes such as sterols, fatty acids and total amino acids. Mixtures may be characterized using, for example, Fourier transform infrared spectroscopy (FTIS). Since the beans contain different amounts of the two main coffee compounds—chlorogenic acid and caffeine—which have distinctive infrared spectra, FTIS may be used to trace coffee beans to their origins (Perks, B., Chemistry World 2007 49-52). Similarly, the micronutrient content of various nutritional substances may be used to trace a nutritional substance to its origin.

In additional embodiments, DNA markers may be used to correlate nutritional substances with their origins. For example, origins of varieties of olive oil may be determined using Random Amplification of Polymorphic DNA (RAPD), Inter Simple Sequence Repeats (ISSR), and Simple Sequence Repeats (SSR) molecular markers (Montealegre, C et al., J. Agric. Food Chem., 2010, 58 (1), pp 28-38; Martin-Lopes, P., J. Agric. Food Chem., 2008, 56 (24), pp 11786-11791; García-Gonzalez, D., J. Agric. Food Chem., 2010, 58 (24), pp 12569-12577). Methods including spectroscopy such as Raman spectroscopy may also be used (Zou et al., J. Agric. Food Chem., 2009, 57 (14), pp 6001-6006; Frankel, E. J. Agric. Food Chem., 2010, 58 (10), pp 5991-6006). Additionally, any one or more of PCR analysis, restriction fragment length polymorphism (RFLP) or lab-on-a-chip capillary electrophoresis methods may also be used to trace nutritional sources to their origins. In further embodiments, mitochondrial DNA may be PCR amplified and sequenced to trace a nutritional substance to its origin. For example, analyzing mitochondrial DNA, 20 species of sardines (genera such as Sardina, Sardinella, Clupea, Ophistonoma and Ilisha) and a similar number of horse mackerel species (Trachurus, Caranx, Mullus, Rastrelliger and others), originating from seas all over the world, were identified (Fatima C. et al., European Food Research and Technology, 2011, 232(6):1077-1086; Fatima C. et al., Journal of Agricultural and Food Chemistry, 2011; 59 (6): 2223-2228).

In various embodiments, differences in biosynthetic pathways may be used to trace nutritional substances to their origin or to determine the purity and/or quality of nutritional substances. For example, differences in biochemical pathways are used to identify corn-fed chicken, which are more expensive. The analytical method exploits the differences between the biosynthetic pathways that exist between maize (C4 pathway) and temperate cereals such as wheat and barley (C3 pathway). C3 and C4 plants provide markedly different ¹³C/¹²C ratios when measured using stable isotope ratio mass spectrometry. Comparison with a database of results from chickens fed differing maize diets provides a means of confirming that a chicken was fed on corn (maize) (Perks, B., Chemistry World 2007 49-52).

In additional embodiments, arrays, including but not limited to sensor-arrays may be used to trace nutritional substances to their origins and/or to determine the origin of nutritional substances from a mixture thereof. For example, colorimetric sensor arrays may be used to distinguish between a variety of coffee beans using their aromas (Suslick et al., Anal Chem 2010 82(5):2067-2073).

Various other technologies may be used to correlate nutritional substances to their origins including but not limited to nanotechnology (Rashidi L and Khosravi-Darani K. 2011 Crit Rev Food Sci Nutr. 2011 51(8):723-30; Staggers et al., Nurs Outlook. 2008 September-October; 56(5):268-74; Chaudhry et al., 2008 Food Addit Contam Part A Chem Anal Control Expo Risk Assess 25(3):241-58; Srinivas et al., J. Nutr. 2010 January;140(1):119-24), chromatography (Lobinski, R. and Szpunar J. Hyphenated techniques in speciation analysis, Royal Society of Chemistr, Cambridge 2003), mass spectrometry (Brinkman, UAT. Hyphenation: hype and fascination, Elsievier Science Ltd, Amsterdam 1999), electronic noses (Walt D R., Anal chem 2005 77:A-45; Gardner J W et al., Electronic noses: principles an applications. Oxford University press, New York, 1999; Aernecke M J, Walt D R. Sens Actuators 2009; 142:464-469; Anslyn E V. J Org Chem 2007; 72:687-699; Lewis N S. Acc Chem Res 2004; 37:663-672; Rock F, Barsan N, Weimar U. Chem Rev 2008; 108:705-725; Hierlemann A, Gutierrez-Osuna R. Chem Rev 2008; 108:563-613; Hsieh M-D, Zellers E T. Anal Chem 2004; 76:1885-1895; Grate J W. Chem Rev 2000; 100:2627-2647; Janata J, Josowicz M. Nat Mater 2003; 2:19-24; Wolfbeis O S. J Mater Chem 2005; 15:2657-2669; 1James D, Scott S M, Ali Z, O'Hare W T. Microchimica Acta 2005; 149:1-17.), determining carbon isotope ratios (Primrose, S., Trends in Food Science and Technology 2010 21(12):582-590), quantitative SNP genotyping (Primrose, S., Trends in Food Science and Technology 2010 21(12):582-590). Additionally, nutritional substances may be genetically modified with, for example, long terminal repeat (LTR) sequences which would serve as unique fingerprints for the nutritional substance. For example, bananas from Mexico may express a LTR sequence that is different compared to the bananas from India. Various genetic and DNA profiling processes may be used to correlate nutritional substances to their origin and would be apparent to a person of skill in the art. Such methods include but are not limited to restriction fragment length polymorphism (RFLP) analysis, polymerase chain reaction (PCR) analysis, short tandem repeats (STR) analysis, amplified fragment length polymorphism (AmpFLP) analysis, mitochondrial DNA analysis or combinations thereof.

A nutritional substance encoding a molecular tag may further comprise an associated label, mechanical tag or and electronic tag. The information about the nutritional substance and the encoded molecular tag about the origin is stored in a storage system. The nutritional content values may provide the starting values for calculating the change in nutritional content (ΔN) as the nutritional substance is transported from the creator to the consumer 600, either directly or indirectly, via any one or more of the preservation system 300, transformation system 400, conditioning system 500, or a combination thereof. As the nutritional substance moves through each of the aforementioned systems, the nutritional content information is updated in the Information Module 100, thus providing a ΔN value and a more accurate representation of the nutritional content in the nutritional substance.

Optionally, the tags may also include information about the nutritional content of the nutritional substance. In some embodiments, information about the creation/origin and the nutritional content of a nutritional substance is on the same tag. Additionally, a single electronic or mechanical tag may encode a unique information identifier that directs a user to a storage system that includes information about the origin, nutritional content and nutritional value of the nutritional substance. A single electronic tag or a single mechanical tag may encode information about the origin and the nutritional content of a nutritional substance. Alternately, a single electronic tag or a single mechanical tag may encode information about the origin and a unique information identifier associated with the nutritional substance. In some embodiments, a single electronic tag or a single mechanical tag may encode information about the origin, the unique information identifier and the nutritional content of a nutritional substance.

Optionally, different tags comprise information about the origin, nutritional content and a unique information identifier for each nutritional substance. For example, a molecular tag (such as a unique nucleic sequence identifier or a unique protein expression pattern) may provide information about the origin of a nutritional substance and a mechanical tag may provide information about the nutritional content and/or a unique information identifier for the nutritional substance

Preservation module 300 preserves nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains source or creation information regarding the nutritional substance from information module 100. Using that information, preservation module 300 may dynamically adapt or modify its preservation process for the nutritional substance to optimize the preservation of the nutritional substance so as to preserve or improve or minimize degradation of at least one of the nutritional, organoleptic, or aesthetic properties of the nutritional substance. In other words, the preservation module 300 can act to optimize at least one ΔN associated with the nutritional substance resulting from preservation.

Additionally, preservation module 300 provides information to information module 100 regarding the nutritional substance during the time it is being preserved and shipped to transformation module 400. This information could include the condition, including a nutritional, organoleptic, or aesthetic value of the nutritional substance when it was received for preservation, the condition, including a nutritional, organoleptic, or aesthetic value of the nutritional substance during its preservation, and the condition, including a nutritional, organoleptic, or aesthetic value of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100.

In the case where the nutritional substance is bananas, preservation module 300 could provide to information module 100 information about the current state of nutritional, organoleptic, or aesthetic values, or one or more ΔNs of the bananas, as well as the exterior and interior conditions of preservation module 300, as well modifications preservation module 300 made to itself to ripen or preserve the bananas during preservation so as to meet optimal nutritional, organoleptic, or aesthetic properties when the bananas arrive at the grocery store.

In the case where the nutritional substance is beef which is being aged during the period it is preserved by preservation module 300, preservation module 300 could provide information module 100 with information regarding the condition, including a nutritional, organoleptic, or aesthetic value of the beef from the time of its delivery to preservation module 300, through the time the beef was preserved by preservation module 300, to when it was removed from preservation module 300. This preservation information provided to information module 100 is preferably a ΔN occurring during the preservation period, or used to determine a ΔN occurring during the preservation period, and could be used by the conditioner of the beef, such as a restaurant, to determine how to properly cook the beef.

Transformation module 400 could retrieve from information module 100 both; creation information provided by creation module 200, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance; and preservation information provided by preservation module 300. Transformation module 400 could use such creation information and preservation information to dynamically adapt or modify the transformation of the nutritional substance to optimize at least one ΔN associated with the nutritional substance resulting from transformation. Additionally, transformation module 400 could provide information module 100 with transformation information.

In the case where the nutritional substance is sweet corn which is to be cooked and canned for consumer consumption, transformation module 400 could use the creation information regarding the composition of the corn, including its nutrients and additives and any nutritional, organoleptic, or aesthetic values to determine how to transform the corn so as to preserve or improve organoleptic and nutritional properties. Transformation module 400 could also use preservation information regarding the corn to modify the transformation in response to changes to the corn which occurred during preservation so as to optimize at least one ΔN associated with the corn resulting from transformation. Additionally, information regarding how the corn was transformed in transformation module 400, such as cooking temperatures and duration and substances added to the canned corn, could be provided by transformation module 400 to information module 100.

By reading and then transmitting source information or a dynamic information identifier unique to a nutritional substance, the conditioning module 500 will be able to recognize the nutritional substance from information it retrieves from a nutritional substance database, such as a dynamic nutritional value database. Various conditioning modules can retrieve this information and will adapt a conditioning protocol according to the information retrieved regarding the nutritional substance. In this way, a conditioning module 500 receives information regarding the nutritional substance from information module 100. This information could include: creation information provided by creation module 200, preservation information provided by preservation module 300, and transformation information from transformation module 400. Additionally, conditioning module 500 could receive recipe information from information module 100, consumer information through consumer module 600 or through consumer queries obtained through a consumer interface provided as part of the conditioning module 500. All such information could be used by conditioning module 500 in the conditioning of the nutritional substance so as to optimize at least one ΔN associated with the corn resulting from conditioning. Additionally, conditioning module 500 can provide information module 100 with conditioning information regarding how the nutritional substance was conditioned, as well as measured or sensed or estimated information as to the state of the nutritional substance before, during and upon completion of conditioning, or a ΔN associated with conditioning.

In the example of a frozen ready-to-eat dinner, conditioning module 500 could use such information provided by information module 100 to optimize the conditioning of the nutritional substance by conditioning module 500. Conditioning module 500 could dynamically adapt or modify the conditioning of the nutritional substance in response to information it receives from information module 100 regarding the nutritional, organoleptic, or aesthetic properties of the nutritional substance. Conditioning module 500 could use information about nutritional substances used as ingredients of the frozen ready-to-eat dinner, such as the transformed corn and beef described above, to modify the defrosting and cooking the frozen ready-to-eat dinner.

Consumer module 600 obtains consumer information from the consumer of the nutritional substance. Such consumer information could include feedback from the consumer as to the quality and taste of the nutritional substance, and could include feedback used to understand or determine a nutritional, organoleptic, or aesthetic value of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is canned Brussels sprouts, the Brussels sprouts would have creation information provided by creation module 200, preservation information from preservation module 300, and transformation information from transformation module 400 before being delivered to consumer module 600. As long as these nutritional substances are provided to the consumer with dynamic information identifiers, the consumer will have the ability to access creation, origin and ΔN information.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption. As long as these nutritional substances are provided to the consumer with dynamic information identifiers, the consumer will have the ability to access creation, origin and ΔN information.

It will also be understood that nutritional substances may pass through nutritional substance supply system 10 more than one time. In the case of the nutritional substance being wheat flour which is eventually used to make bread, the wheat grain may pass through creation module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database. Preferably, information module 100 is set up as and intelligent database, capable of creating traffic and signing on the address of consumers, which would be a key source of business and also allow for the rapid adoption of nutritional information systems according to the present invention.

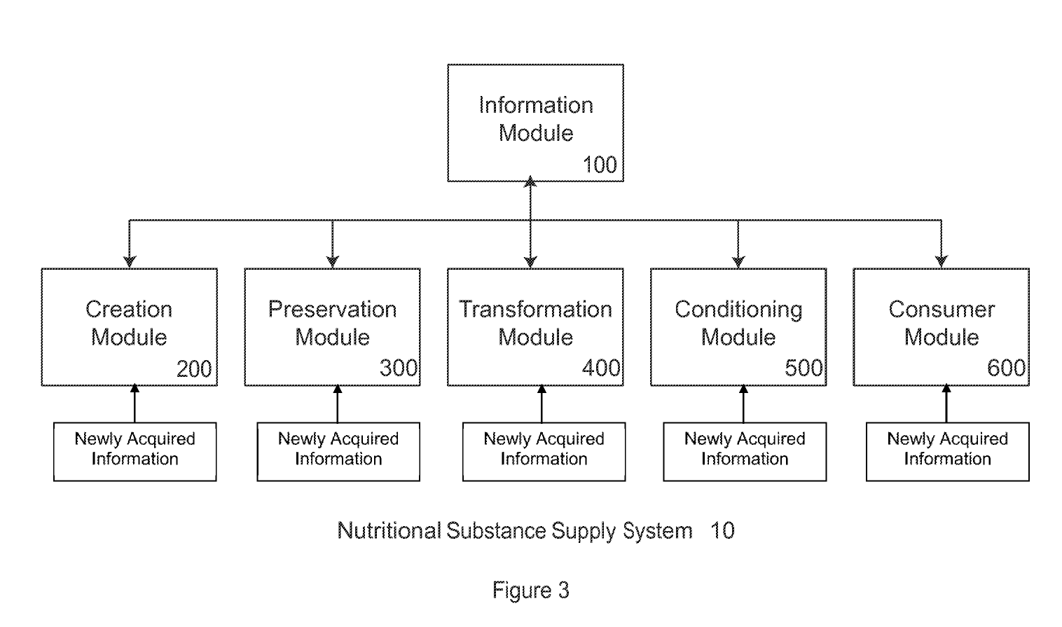

In FIG. 3, information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

Creation module 200 collects information regarding a particular nutritional substance, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance, and where the nutritional substance was delivered. This creation information can be delivered by creation module 200 to information module 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and corresponding initial nutritional, organoleptic, or aesthetic values of the corn and to whom the corn was delivered could also be collected. The farmer would provide such information to information module 100.

In the case where nutritional substance is beef hamburger meat, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered and if slaughtered, corresponding initial nutritional, organoleptic, or aesthetic values of the resulting products. All such creation information would be provided by the rancher to information module 100.

Preservation module 300 preserves a nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains source or creation information regarding the nutritional substance from information module 100. Using that information, preservation module 300 may dynamically adapt or modify its preservation process for the nutritional substance to optimize the preservation of the nutritional substance so as to preserve or improve or minimize degradation of at least one of the nutritional, organoleptic, or aesthetic properties of the nutritional substance. In other words, the preservation module 300 can act to optimize at least one ΔN associated with the nutritional substance resulting from preservation.

Additionally, preservation module 300 provides information to information module 100 regarding the nutritional substance during the time it is being preserved and shipped to transformation module 400. This information could include the condition, including a nutritional, organoleptic, or aesthetic value of the nutritional substance when it was received for preservation, the condition, including a nutritional, organoleptic, or aesthetic value of the nutritional substance during its preservation, and the condition, including a nutritional, organoleptic, or aesthetic value of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100.

In the case where the nutritional substance is bananas, preservation module 300 could provide to information module 100 information about the current state of nutritional, organoleptic, or aesthetic values, or one or more ΔNs of the bananas, as well as the exterior and interior conditions of preservation module 300, as well modifications preservation module 300 made to itself to ripen or preserve the bananas during preservation so as to meet optimal nutritional, organoleptic, or aesthetic properties when the bananas arrive at the grocery store.

In the case where the nutritional substance is beef which is being aged during the period it is preserved by preservation module 300, preservation module 300 could provide information module 100 with information regarding the condition, including a nutritional, organoleptic, or aesthetic value of the beef from the time of its delivery to preservation module 300, through the time the beef was preserved by preservation module 300, to when it was removed from preservation module 300. This preservation information provided to information module 100 is preferably a ΔN occurring during the preservation period, or used to determine a ΔN occurring during the preservation period, and could be used by the conditioner of the beef, such as a restaurant, to determine how to properly cook the beef.

Transformation module 400 could retrieve from information module 100 both; creation information provided by creation module 200, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance; and preservation information provided by preservation module 300. Transformation module 400 could use such creation information and preservation information to dynamically adapt or modify the transformation of the nutritional substance to optimize at least one ΔN associated with the nutritional substance resulting from transformation. Additionally, transformation module 400 could provide information module 100 with transformation information.

In the case where the nutritional substance is sweet corn which is to be cooked and canned for consumer consumption, transformation module 400 could use the creation information regarding the composition of the corn, including its nutrients and additives and any nutritional, organoleptic, or aesthetic values to determine how to transform the corn so as to preserve or improve organoleptic and nutritional properties. Transformation module 400 could also use preservation information regarding the corn to modify the transformation in response to changes to the corn which occurred during preservation so as to optimize at least one ΔN associated with the corn resulting from transformation. Additionally, information regarding how the corn was transformed in transformation module 400, such as cooking temperatures and duration and substances added to the canned corn, could be provided by transformation module 400 to information module 100.

By reading and then transmitting source information or a dynamic information identifier unique to a nutritional substance, the conditioning module 500 will be able to recognize the nutritional substance from information it retrieves from a nutritional substance database. Various conditioning modules can retrieve this information and will adapt a conditioning protocol according to the information retrieved regarding the nutritional substance. In this way, a conditioning module 500 receives information regarding the nutritional substance from information module 100. This information could include creation information provided by creation module 200, preservation information provided by preservation module 300, and transformation information from transformation module 400. Additionally, conditioning module 500 could receive recipe information from information module 100, consumer information through consumer module 600 or through consumer queries obtained through a consumer interface provided as part of the conditioning module 500. All such information could be used by conditioning module 500 in the conditioning of the nutritional substance so as to optimize at least one ΔN associated with the corn resulting from conditioning. Additionally, conditioning module 500 can provide information module 100 with conditioning information regarding how the nutritional substance was conditioned, as well as measured or sensed or estimated information as to the state of the nutritional substance before, during and upon completion of conditioning, or a ΔN associated with conditioning.

In the example of a frozen ready-to-eat dinner, conditioning module 500 could use such information provided by information module 100 to optimize the conditioning of the nutritional substance by conditioning module 500. Conditioning module 500 could dynamically adapt or modify the conditioning of the nutritional substance in response to information it receives from information module 100 regarding the nutritional, organoleptic, or aesthetic properties of the nutritional substance. Conditioning module 500 could use information about nutritional substances used as ingredients of the frozen ready-to-eat dinner, such as the transformed corn and beef described above, to modify the defrosting and cooking the frozen ready-to-eat dinner.

Consumer module 600 obtains consumer information from the consumer of the nutritional substance. Such consumer information could include feedback from the consumer as to the quality and taste of the nutritional substance, and could include feedback used to understand or determine a nutritional, organoleptic, or aesthetic value of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is canned Brussels sprouts, the Brussels sprouts would have creation information provided by creation module 200, preservation information from preservation module 300, and transformation information from transformation module 400 before being delivered to consumer module 600. As long as these nutritional substances are provided to the consumer with dynamic information identifiers, the consumer will have the ability to access creation, origin and ΔN information.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption. As long as these nutritional substances are provided to the consumer with dynamic information identifiers, the consumer will have the ability to access creation, origin and ΔN information.

It will also be understood that nutritional substances may pass through nutritional substance supply system 10 more than one time. In the case of the nutritional substance being wheat flour which is eventually used to make bread, the wheat grain may pass through creation module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database. Preferably, information module 100 is set up as and intelligent database, capable of creating traffic and signing on the address of consumers, which would be a key source of business and also allow for the rapid adoption of nutritional information systems according to the present invention.

Information module 100 may also contain information regarding the consumer of the nutritional substance. This information could include the consumer's medical history, current physical condition, including height, weight and BMI. Additional consumer information could include specific dietary needs, such as vitamin and mineral levels and food allergies. Additional consumer information could include food preferences, such as disliking cilantro or preferring well-cooked meat, or al dente pasta. Dietary preferences could also include whether the consumer is vegetarian, vegan, kosher, macrobiotic, gluten free, etc. Additional consumer information could include current dietary programs such as being on a diet, such as the South Beach diet, the Atkins diet, the Weight Watchers diet, or a diet provided by the consumer's physician.

Information module 100 could track the nutritional substances consumed to track and manage the diets of consumers. For example, a consumer who is on dialysis must manage the levels of certain chemicals in their blood for the dialysis to be effective. Information module 100 could track such information regarding nutritional substances being consumed. Additionally, information module 100 could provide information to consumer module 600 to assist in nutritional substance selection, including menu planning. This could include not only suggestions as to nutritional substances to be consumed, but also nutritional substances that should not be consumed and alerts or warnings when a consumer may be considering the purchase, consumption, or conditioning of a nutritional substance that should not be consumed. Further, such information from information module 100 could allow consumer module 600 to suggest compromises in the selection of nutritional substances.

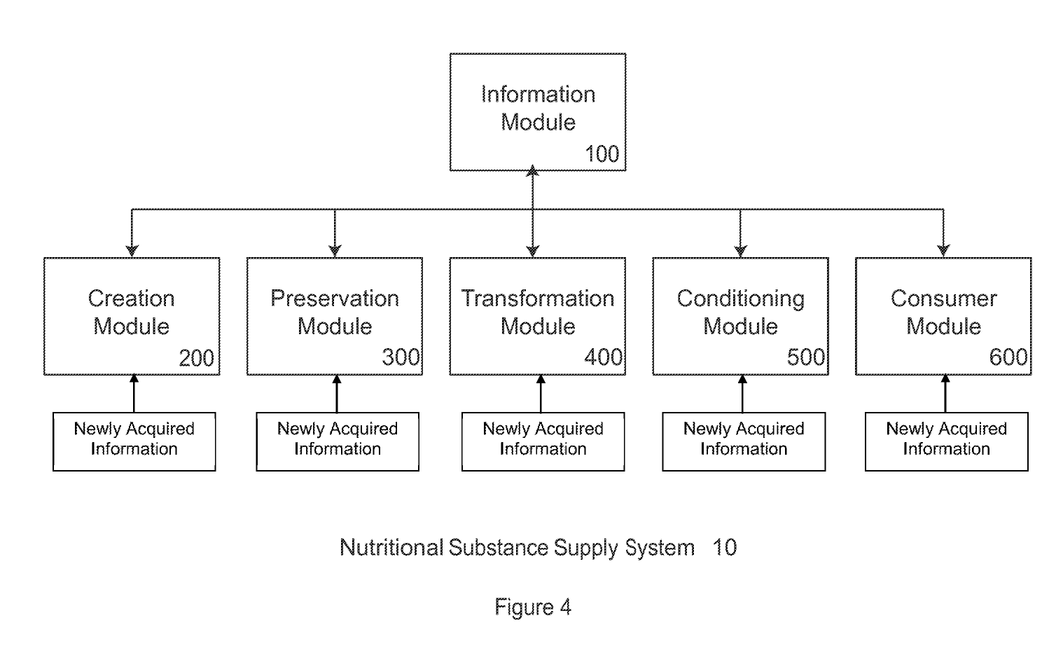

In FIG. 4, Information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Such information includes information regarding a ΔN and may further include source information and a dynamic information identifier. Additionally, information module 100 can provide such collected information to the other modules, as well as outside parties not part of nutritional substance industry 10, wherein such information may be accessible by referencing at least one of the dynamic information identifier and the source information.

Creation module 200 collects information regarding a particular nutritional substance, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance, and where the nutritional substance was delivered. This creation information can be delivered by creation module 200 to information module 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and corresponding initial nutritional, organoleptic, or aesthetic values of the corn and to whom the corn was delivered could also be collected. The farmer would provide such information to information module 100.

In the case where nutritional substance is beef hamburger meat, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered and if slaughtered, corresponding initial nutritional, organoleptic, or aesthetic values of the resulting products. All such creation information would be provided by the rancher to information module 100.

Preservation module 300 preserves nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains source or creation information regarding the nutritional substance from information module 100. Using that information, preservation module 300 may dynamically adapt or modify its preservation process for the nutritional substance to optimize the preservation of the nutritional substance so as to preserve or improve or minimize degradation of at least one of the nutritional, organoleptic, or aesthetic properties of the nutritional substance. In other words, the preservation module 300 can act to optimize at least one ΔN associated with the nutritional substance resulting from preservation.

Additionally, preservation module 300 provides information to information module 100 regarding the nutritional substance during the time it is being preserved and shipped to transformation module 400. This information could include the condition, including a nutritional, organoleptic, or aesthetic value of the nutritional substance when it was received for preservation, the condition, including a nutritional, organoleptic, or aesthetic value of the nutritional substance during its preservation, and the condition, including a nutritional, organoleptic, or aesthetic value of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100.

In the case where the nutritional substance is bananas, preservation module 300 could provide to information module 100 information about the current state of nutritional, organoleptic, or aesthetic values, or one or more ΔNs of the bananas, as well as the exterior and interior conditions of preservation module 300, as well modifications preservation module 300 made to itself to ripen or preserve the bananas during preservation so as to meet optimal nutritional, organoleptic, or aesthetic properties when the bananas arrive at the grocery store.

In the case where the nutritional substance is beef which is being aged during the period it is preserved by preservation module 300, preservation module 300 could provide information module 100 with information regarding the condition, including a nutritional, organoleptic, or aesthetic value of the beef from the time of its delivery to preservation module 300, through the time the beef was preserved by preservation module 300, to when it was removed from preservation module 300. This preservation information provided to information module 100 is preferably a ΔN occurring during the preservation period, or used to determine a ΔN occurring during the preservation period, and could be used by the conditioner of the beef, such as a restaurant, to determine how to properly cook the beef. Transformation module 400 could retrieve from information module 100 both; creation information provided by creation module 200, such as source information regarding the origin or genesis of the nutritional substance, information regarding the growing or raising of the nutritional substance, information regarding the harvesting or slaughtering of the nutritional substance and corresponding initial nutritional, organoleptic, or aesthetic values of the nutritional substance; and preservation information provided by preservation module 300. Transformation module 400 could use such creation information and preservation information to dynamically adapt or modify the transformation of the nutritional substance to optimize at least one ΔN associated with the nutritional substance resulting from transformation. Additionally, transformation module 400 could provide information module 100 with transformation information.

In the case where the nutritional substance is sweet corn which is to be cooked and canned for consumer consumption, transformation module 400 could use the creation information regarding the composition of the corn, including its nutrients and additives and any nutritional, organoleptic, or aesthetic values to determine how to transform the corn so as to preserve or improve organoleptic and nutritional properties. Transformation module 400 could also use preservation information regarding the corn to modify the transformation in response to changes to the corn which occurred during preservation so as to optimize at least one ΔN associated with the corn resulting from transformation. Additionally, information regarding how the corn was transformed in transformation module 400, such as cooking temperatures and duration and substances added to the canned corn, could be provided by transformation module 400 to information module 100.

By reading and then transmitting source information or a dynamic information identifier unique to a nutritional substance, the conditioning module 500 will be able to recognize the nutritional substance from information it retrieves from a nutritional substance database. Various conditioning modules can retrieve this information and will adapt a conditioning protocol according to the information retrieved regarding the nutritional substance. In this way, a conditioning module 500 receives information regarding the nutritional substance from information module 100. This information could include creation information provided by creation module 200, preservation information provided by preservation module 300, and transformation information from transformation module 400. Additionally, conditioning module 500 could receive recipe information from information module 100, consumer information through consumer module 600 or through a consumer queries obtained through a consumer interface provided as part of the conditioning module 500. All such information could be used by conditioning module 500 in the conditioning of the nutritional substance so as to optimize at least one ΔN associated with the corn resulting from conditioning. Additionally, conditioning module 500 can provide information module 100 with conditioning information regarding how the nutritional substance was conditioned, as well as measured or sensed or estimated information as to the state of the nutritional substance before, during and upon completion of conditioning, or a ΔN associated with conditioning.

In the example of a frozen ready-to-eat dinner, conditioning module 500 could use such information provided by information module 100 to optimize the conditioning of the nutritional substance by conditioning module 500. Conditioning module 500 could dynamically adapt or modify the conditioning of the nutritional substance in response to information it receives from information module 100 regarding the nutritional, organoleptic, or aesthetic properties of the nutritional substance. Conditioning module 500 could use information about nutritional substances used as ingredients of the frozen ready-to-eat dinner, such as the transformed corn and beef described above, to modify the defrosting and cooking the frozen ready-to-eat dinner.

Consumer module 600 obtains consumer information from the consumer of the nutritional substance. Such consumer information could include feedback from the consumer as to the quality and taste of the nutritional substance, and could include feedback used to understand or determine a nutritional, organoleptic, or aesthetic value of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is canned Brussels sprouts, the Brussels sprouts would have creation information provided by creation module 200, preservation information from preservation module 300, and transformation information from transformation module 400 before being delivered to consumer module 600. As long as these nutritional substances are provided to the consumer with dynamic information identifiers, the consumer will have the ability to access creation, origin and ΔN information.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption. As long as these nutritional substances are provided to the consumer with dynamic information identifiers, the consumer will have the ability to access creation, origin and ΔN information.

It will also be understood that nutritional substances may pass through nutritional substance supply system 10 more than one time. In the case of the nutritional substance being wheat flour which is eventually used to make bread, the wheat grain may pass through creation module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database. Preferably, information module 100 is set up as and intelligent database, capable of creating traffic and signing on the address of consumers, which would be a key source of business and also allow for the rapid adoption of nutritional information systems according to the present invention.

Information module 100 may also contain information regarding the consumer of the nutritional substance. This information could include the consumer's medical history, current physical condition, including height, weight and BMI. Additional consumer information could include specific dietary needs, such as vitamin and mineral levels and food allergies. Additional consumer information could include food preferences, such as disliking cilantro or preferring well-cooked meat, or al dente pasta. Dietary preferences could also include whether the consumer is vegetarian, vegan, kosher, macrobiotic, gluten free, etc. Additional consumer information could include current dietary programs such as being on a diet, such as the South Beach diet, the Atkins diet, the Weight Watchers diet, or a diet provided by the consumer's physician.

Information module 100 could track the nutritional substances consumed to track and manage the diets of consumers. For example, a consumer who is on dialysis must manage the levels of certain chemicals in their blood for the dialysis to be effective. Information module 100 could track such information regarding nutritional substances being consumed. Additionally, information module 100 could provide information to consumer module 600 to assist in nutritional substance selection, including menu planning. This could include not only suggestions as to nutritional substances to be consumed, but also nutritional substances that should not be consumed and alerts or warnings when a consumer may be considering the purchase, consumption, or conditioning of a nutritional substance that should not be consumed. Further, such information from information module 100 could allow consumer module 600 to suggest compromises in the selection of nutritional substances.

Information module 100 is preferably implemented as a massive, multidimensional database operated on multiple computing devices across an interconnecting network. Such a database could be hosted by a plurality of nutritional substance creators, preservers, transformers, conditioners, or consumers. Preferably, information module 100 is maintained and operated by a global entity which operates the system for the benefit of all participants in the nutritional substance supply system 10. In such an information module 100, the global entity could be remunerated on a per-transaction basis for receiving nutritional substance information or providing nutritional substance information.

In another business model for the global entity operating information module 100, access to the module by participants in the supply chain could be at no charge. However, the global entity could receive remuneration for access by non-participants such as research and marketing organizations. Alternatively, participants in the supply chain could pay to advertise to other participants in the supply chain as part of their access to the information in information module 100.

Information transfer throughout nutritional substance supply system 10, to and from information module 100 can be accomplished through various computer information transmission systems, such as the internet. Such interconnection could be accomplished by wired networks and wireless networks, or some combination thereof. Wireless networks could include WiFi local area networks, Bluetooth networks, but preferably wireless telecommunication networks.

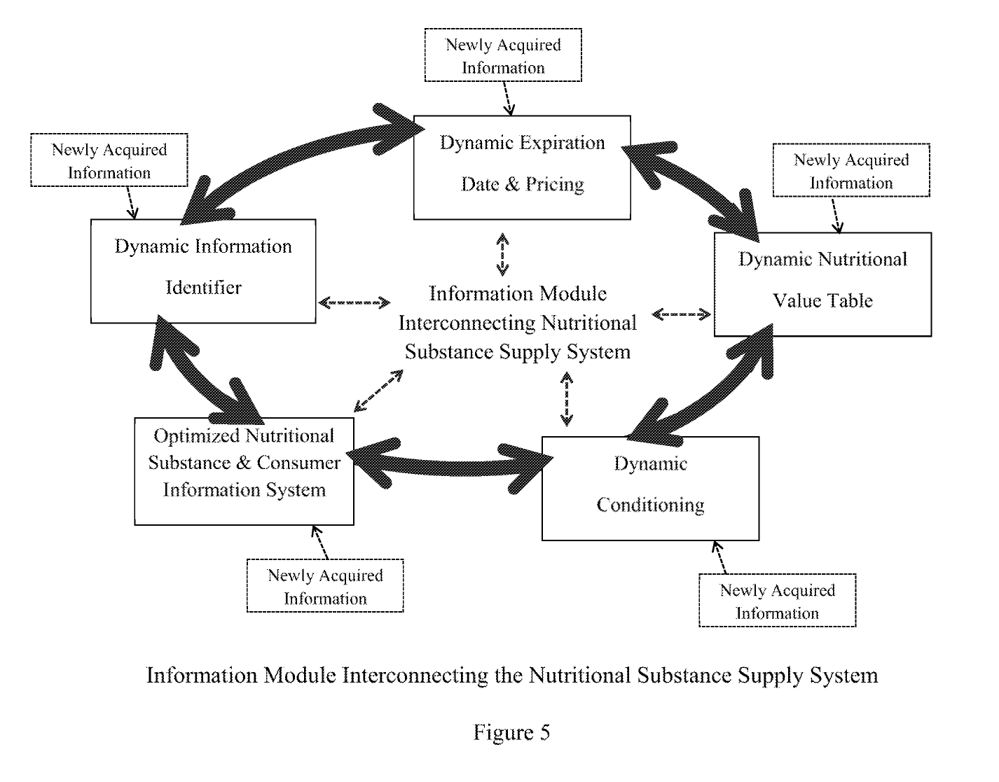

FIG. 5 shows how the information module of the present invention functions to facilitate collection, preservation, and distribution of various types of dynamic information about an information-enabled nutritional substance and a consumer of the information-enabled nutritional substance.

As indicated in FIG. 5 by “Dynamic Information Identifier”, a nutritional substance is provided with a dynamic information identifier. The dynamic information identifier is a reference associated with source, origin and ΔN information regarding the nutritional substance collected and preserved by an information module interconnecting the nutritional substance supply system, as indicated by “Information Module Interconnecting Nutritional Substance Supply System”.

As indicated in FIG. 5 by “Dynamic Expiration Date & Pricing”, the information module of the present invention, which tracks ΔN information for the information-enabled nutritional substance, facilities the determination of a dynamic expiration date and dynamic pricing for the information-enabled nutritional substance.

As indicated in FIG. 5 by “Dynamic Nutritional Value Table”, the information module of the present invention, which tracks ΔN information for the information-enabled nutritional substance, facilities the determination of a dynamic nutritional value table for the information-enabled nutritional substance.

As indicated in FIG. 5 by “Dynamic Conditioning”, the information module of the present invention, which tracks ΔN information for the information-enabled nutritional substance and can estimate ΔN associated with proposed conditioning parameters, facilities the determination of dynamic conditioning parameters which are responsive to the ΔN of the information-enabled nutritional substance prior to conditioning, the ΔN of the information-enabled nutritional substance resulting from conditioning, and further responsive to the consumer's preferences and needs.

As indicated in FIG. 5 by “Optimized Nutritional Substance & Consumer Information System”, the information module of the present invention, which tracks ΔN information for the information-enabled nutritional substance and can estimate ΔN associated with proposed conditioning parameters, facilities the collection of information related to the consumer and his preferences and needs in nutritional substances.

### EXAMPLES OF THE INVENTION

To illustrate benefits of the present invention the following example is provided of a consumer who is faced with making a purchasing decision based on several variables. A consumer would like to make an Italian entrée for dinner on Friday, but must go to the market on Monday (4 days in advance of preparing the entrée), and is not sure of an appropriate recipe to meet his unique needs, for example, nutritional substances low in sodium, gluten-free and high in lycopene. The consumer uses his smartphone to: access a nutritional substance information module that has access to a consumer module with the consumer's personal consumer profile, including low sodium, gluten-free and high lycopene preferences, and retrieves appropriate recipes; or alternatively, the consumer might use his smartphone to access various recipe databases for Italian recipes using an application on his smartphone to filter the recipes according to his consumer profile, including low sodium, gluten-free and high lycopene; or alternatively, the consumer might use his smartphone to access a recipe database for Italian recipes wherein the database provides consumer interface through the consumer's smartphone screen to provide input regarding the consumer's needs, such as low sodium, gluten-free and high lycopene. In this way, the consumer obtains a recipe comprising a list of ingredients for an entrée that meets his essential health needs, and can capture the recipe. In this case, the consumer has selected a recipe for gluten-free pasta with marinara sauce.

The consumer then uses his smartphone, tablet computer, or personal computer to locate nearby supermarkets and verify if the supermarkets have all of the required ingredients to make the desired gluten-free pasta with marinara sauce, plus other items he needs to purchase, such as a specific bottle of wine and cheese to enjoy with the entrée. Unfortunately, all of the ingredients and other items are not available at his preferred supermarket, but he finds that they are available at an alternate supermarket nearby. He is not familiar with the alternate supermarket, and does not know the locations of the various ingredients or the other items in the unfamiliar supermarket, so in order to make his shopping experience more efficient he uses his smartphone, tablet computer, or personal computer to request the location of the ingredients and other items within the supermarket and the fastest route within the supermarket to collect the items on his shopping list. For example, the consumer's smartphone utilizes an application created for the alternate supermarket to identify the location within the alternate supermarket of the various items on his shopping list and generate a route within the alternate supermarket that the consumer can follow that will result in the least amount of time required for collecting the ingredients. The suggested route may instruct that he starts in the produce isle of the supermarket, in this case isle number 1, and provide the list of ingredients to collect at that location. As he collects the various ingredients required from the produce isle, his smartphone can allow him to delete a collected item, change its status to indicate it has been collected, or may allow him to move it from a list of items to be collected to a list of items collected. Upon collecting the last item from the produce isle, the smartphone instructs him to go to the specific isle where the low sodium, gluten-free pasta can be found, which in this case is isle 11. Upon collecting the gluten-free pasta from isle 11, the smartphone instructs him to go to the specific isle where wine is located, which in this case is isle 14. Upon collecting the wine from isle 14, the smartphone instructs him to go to the specific isle where cheese can be found, in this case isle 15. In this way, the consumer's time spent locating and collecting the items required for purchase is minimized because he is able to make one quick pass through the supermarket, visiting only the correct location for each item, and with no backtracking. Additionally, his smartphone can easily verify that all required items have been collected. Further, his smartphone can be used to retrieve a dynamic information identifier from each dynamically-labeled nutritional substance considered for purchase so that he may retrieve related source and ΔN information from a nutritional value database in the nutritional substance information module. Preferably, the dynamically-labeled nutritional substance is provided with a QR code including the dynamic information identifier and a URL to hardlink the consumer to the nutritional substance information module. The consumer would use his smartphone to scan such a QR code on a nutritional substance of interest. The smartphone would then hardlink the consumer to the nutritional substance information module and retrieve source and ΔN information associated with the dynamic information identifier.

If no single supermarket has all of the ingredients and other items are required, the consumer can still retrieve a route requiring the least time to collect the items from multiple supermarkets. For example, if the consumer must visit two supermarkets to collect all items, the route retrieved can include both the driving instructions from the consumer's home to a first supermarket, the route to follow within the first supermarket, driving instructions from the first supermarket to a second supermarket, the route to follow within the second supermarket, and driving instructions from the second supermarket to the consumer's home. Further, his smartphone can be used to retrieve a dynamic information identifier from any dynamically labeled nutritional substance, which are provided with a dynamic information identifier, so that he may retrieve related source and ΔN information from a dynamic nutritional value database in the nutritional substance information module. Preferably, the nutritional substance dynamic labeling comprises a QR code including the dynamic information identifier and a URL to hardlink the consumer to the nutritional substance information module.

The consumer goes to the supermarket to purchase the ingredients for the desired entrée. The consumer is interested in preparing a meal that meets his needs when it is prepared 4 days from the time of purchase. The recipe calls for tomatoes and pasta among the ingredients. The consumer uses his smartphone to scan dynamic labeling on Heirloom tomatoes, such as by scanning a QR code including the dynamic information identifier and a URL to hardlink the consumer to the nutritional substance information module, to access the dynamic nutritional value database to verify if the Heirloom tomatoes will meet his needs for high lycopene when prepared in 4 days, and finds that they will not, based upon their current nutritional value and the ΔN associated with 4 days storage at expected storage conditions. The consumer may then use his smartphone to scan dynamic labeling on Roma tomatoes, such as by scanning a QR code including the dynamic information identifier and a URL to hardlink the consumer to the nutritional substance information module, to access the dynamic nutritional value database and find that the Roma tomatoes will meet his high lycopene needs when prepared in 4 days from now, based upon their current nutritional value and the ΔN associated with 4 days storage at expected storage conditions, and therefore decides to purchase Roma tomatoes. In a similar fashion, the consumer scans a QR code including a dynamic information identifier and URL for the nutritional substance information module on one or more pasta products, accesses the dynamic nutritional value database and finds out if the products meet, or do not meet, his low sodium and gluten-free needs when prepared in 4 days, and then makes purchasing decisions regarding pasta. The consumer is not the only entity that has benefited from the dynamic nutritional information about the Heirloom tomatoes, the Roma tomatoes and the pasta, as data regarding the consumer's needs for low sodium, gluten-free, and high lycopene have been collected by the consumer module and correlated with the respective dynamic information identifiers, and are available to, such as transmitted to, the information module and are of particular interest and accessible to the growers and packagers of the respective tomatoes and to the transformer of the one or more pastas. The dynamic nutritional value database will also provide ΔN information of how the nutritional values of any other ingredients he is buying will evolve during the next 4 days (tomatoes, pasta, garlic, onions, basil etc. . . . ) if those ingredients are dynamically labeled and supplied with dynamic information identifiers. This consumer information can be saved and be made available to all other entities in the nutritional substance supply system.

Also, while shopping for the ingredients for the pasta with marinara sauce, the consumer decides to buy a bottle of wine and some cheese to go with the meal. Using his smartphone to read QR codes (providing dynamic information identifiers and URL to the nutritional substance information module) form bottles of wine and cheeses he is considering for purchase, he can retrieve information from the dynamic nutritional value database with his smartphone regarding source and ΔN information of those products, and can make informed decisions on the maturity of nutritional substances that actually discompose to be ready to eat or drink, like the cheese and the bottle of wine, and can now see how good it will be to enjoy it in 4 days.

When the consumer is ready to prepare the recipe for pasta with marinara sauce, he uses his smartphone to read QR codes (providing dynamic information identifiers and URL to the nutritional substance information module) from the tomatoes he has purchased in order to access the nutritional substance information module containing dynamic nutritional values for the tomatoes identified by the specific dynamic information identifier. The nutritional substance information module has source and ΔN information regarding changes in lycopene levels of the tomatoes, and uses that information to modify a conditioning protocol, in this case the conditioning protocol associated with the recipe chosen by the consumer, such that lycopene levels are minimally degraded, maintained, or enhanced, such as by recommending changes to cooking temperature and cooking time. The consumer also uses his smartphone to read QR codes (providing dynamic information identifiers and URL to the nutritional substance information module) from the pasta he has purchased in order to access the nutritional substance information module containing dynamic nutritional values for the pasta identified by the specific dynamic information identifier. The nutritional substance information module has source and ΔN information regarding the pasta. Further, the consumer's preference for al dente texture may be available as part of a consumer specific profile within the consumer module, or may result from a query required by the conditioning protocol, in this case the conditioning protocol associated with the recipe chosen by the consumer, and provided through the consumer's smartphone. The information is used by the nutritional substance information module to modify the conditioning protocol for the pasta, such as by modifying the amount of time in boiling water.

To illustrate other benefits of the present invention, another example is provided of a consumer who is faced with making a consumption decision regarding an information-enabled nutritional substance he has already purchased. In this example, a consumer has purchased Heirloom tomatoes to make a salad. The consumer knows that Heirloom tomatoes are only ripe for a short time, and does not want them to become overripe before preparing the salad. In this case, knowing a dynamic expiration date, that is, an actual “best use” date, for the tomatoes would be far more valuable than the static expiration information currently available. The consumer could use his smartphone to read a QR code (providing dynamic information identifiers and URL to the nutritional substance information module) from the tomatoes he has purchased, and find that based upon dynamically generated data available through the dynamic nutritional value database in the nutritional substance information module, the tomatoes will become overripe in 1 day. This dynamic expiration information would alert the consumer that the actual “best use” date is close, and he should consider using the tomatoes soon. Here again, the consumer is not the only entity that has benefited from the dynamic nutritional information about the Heirloom tomatoes, as data regarding the consumer's needs for ripened tomatoes have been collected by the consumer module and correlated with the respective dynamic information identifiers, and are available and of particular interest to the growers and packagers of the Heirloom tomatoes.

To illustrate additional benefits of the present invention the following example is provided of a supermarket that is faced with making a purchasing decision regarding a nutritional substance it is considering for purchase. In this example, a supermarket considers the purchase of information-enabled peaches from two different suppliers. The supermarket knows that peaches are only ripe for a short time, and does not want them to become overripe before sale. In this case, knowing a dynamic expiration date, that is, an actual “best use” date, for the peaches would be far more valuable than static expiration information currently available to the supermarket, and more valuable than simply following FIFO inventory practices. The supermarket could use the dynamic information identifier for the peaches it is contemplating for purchase, such as by scanning a QR code received by facsimile or e-mail or downloaded from the supplier's website, and find that based upon dynamically generated data available through the dynamic nutritional value database in the nutritional substance information module, the peaches from one supplier will become overripe 2 days earlier than their expected sales cycle, while peaches from the other supplier will not become overripe until 2 days past their expected sales cycle, and in addition would find the actual ΔN curve of what it means for the nutritional values when the peaches from both suppliers become overripe. This dynamic expiration information would inform the supermarket's purchasing decision. The dynamic expiration information would further inform the supermarket's pricing strategy. For example, as peaches the supermarket has purchased approach their dynamic expiration date regarding ripeness, the supermarket could reduce the price of the peaches such that they are depleted from inventory. The supermarket is not the only entity that has benefited from the dynamic nutritional information about the peaches, as data regarding the supermarket's preference for extended dynamic expiration dates is also available, and of particular interest, to the growers and packagers of the respective peaches. The grower and packager of the products with longer dynamic shelf life can additionally require a premium price for their products.

To illustrate still other benefits of the present invention the following example is provided of a consumer who purchases an information-enabled ready-to-eat dinner and uses a microwave oven that is capable of processing information-enabled nutritional substances to prepare the ready-to-eat meal. The consumer goes to the supermarket seeking a particular type of information-enabled ready-to-eat meal. His selection process includes using a smartphone to read a QR code (providing dynamic information identifiers and URL to the nutritional substance information module) from the information-enabled ready-to-eat dinner, using his smartphone to retrieve information from the nutritional substance information module, and verifying that the dinner meets his needs. The consumer later uses a microwave oven that is capable of processing information-enabled nutritional substances to prepare the ready-to-eat dinner. In the process of conditioning the ready-to-eat dinner, the microwave reads the dynamic information identifier from a QR code on the ready-to-eat dinner. Using the dynamic information identifier the microwave retrieves information from the nutritional substance information module regarding the ready-to-eat dinner such as nutritional, organoleptic, or aesthetic values, ΔN information, and preparation information such as a conditioning protocol. The conditioning module, which could have multiple technologies, i.e. microwave, grill, oven, convection, steam etc., then provides the consumer options of preparation and ΔN information for nutritional values expected from exposure to different cooking methods and the time it is exposed. This will enable the consumer to choose his preferred option for preparing this ready-to-eat dinner according to the information retrieved (very much like the options in automobile GPS routing systems where the user can chose fastest route, shortest route and type of road, but here instead of the time and fuel consumed to get to a destination he would be able to have information on time, technology and nutritional values). When the consumer sets his preference and the Conditioning module finishes preparing the ready-to-eat dinner, the Conditioning module also provides the information regarding the ready-to-eat dinner it received from the nutritional substance information module along with information it collected regarding the conditioning of the ready-to-eat dinner to the consumer module, which could be a smartphone or tablet computer. The consumer module, for example the consumer's smartphone, would obtain consumer information regarding the consumption of the ready-to-eat dinner. The smartphone can additionally obtain information relevant to the ready-to-eat dinner, which may include consumer feedback, observations, or measurements regarding the nutritional, organoleptic, aesthetic value of the ready-to-eat dinner before or after conditioning. The consumer module can share this information, through the information module, with those in the nutritional substance supply chain responsible for the ready-to-eat dinner.

As mentioned above, a consumer utilizing the consumer information system of the present invention can benefit from in-store routing technologies to assist his efforts to efficiently locate and purchase nutritional substances. An in-store routing technology placing little to no burden on the consumer, placing little to no burden on the retailer, facilitating improved shopping efficiency, and further allowing monetary benefit to both retailer and consumer based on transactions would favor adoption. Ideally, the consumer would be able to utilize his smart phone to navigate within any establishment that was appropriately navigation enabled. Ideally, the retail establishment would require no additional equipment or infrastructure to become navigation enabled.

A technology that can provide these advantages is ambient magnetic field anomaly-based positioning. The technology utilizes local variations in the Earth's magnetic field to map an indoor location. Variations to the Earth's magnetic field commonly exist inside of modern buildings and are a result of the overall structures of the building. The Earth's magnetic field and the magnetic anomalies created by a specific building create a unique three dimensional magnetic footprint of the interior of the building. Evolving software applications combined with smartphones capable of sensing and recording the resulting magnetic field anomalies can be used to map indoor locations. IndoorAtlas, Ltd. is a company that offers software tools enabling this technology, allowing retailers to magnetically map the interior of a building, such as a modern supermarket, using an Android smartphone and enabling consumers to navigate the interior of the building using their Android smartphone. Depending on the type of building, the accuracy of the technology in modern buildings ranges from 0.1 meter to 2 meters.

This enables the creation of indoor location-awareness applications to enhance the consumer's shopping experience, for example, at a supermarket. Such applications could provide the consumer not only with the availability and location of items on the consumer's shopping list, but with the most efficient route to follow within the supermarket when collecting the items, even leading them on the best route within the supermarket. Further, such applications could identify product alternatives, price, price per unit, promotions such as product rebates, transaction rebates specific to use of the application, and could further suggest complimentary items which are likely to accompany or enhance a target item.

Ideally, the nutritional substances identified would only include information-enabled nutritional substances with dynamic information identifiers on the product itself, enabling the consumer to retrieve source and ΔN information from a nutritional substance information module also using their smartphone. If nutritional substances with and without dynamic information identifiers were identified, a transaction rebate related to the purchase of nutritional substances with dynamic information identifiers could be available.

Examples of how a consumer might benefit from utilizing such an indoor location-awareness application are now provided. The examples will focus on an application that works with the consumer's smartphone in an appropriately navigation enabled supermarket, such as a navigation-enabled supermarket.

The consumer can use an indoor location-awareness application to create a shopping list for nutritional substances and identify the supermarket where he will shop. Alternatively, the consumer could create the shopping list and identify the supermarket where he will shop using other software and send it to the indoor location-awareness application. Using information regarding the contents of the chosen navigation-enabled supermarket the application creates a modified shopping list. The modified shopping list includes the primary items from the consumer's shopping list, and in some cases, variations or alternatives of those items. Further, the modified shopping list may include added items that are complimentary to the primary and alternative items. For example, shredded parmesan cheese could be suggested as a complementary item to pasta and pasta alternatives on the shopping list. Using the modified shopping list, the consumer can see and compare price or price per unit of items on list, including rebates associated with each item, which items can be purchased with an electronic coupon provided by the application, or which items are information-enabled and supplied with a dynamic information identifier. It is preferable that the modified shopping list is generated and presented to the consumer before the consumer begins shopping, in which case the consumer may select various primary, alternative, and complementary items. When the consumer has accepted items from the modified shopping list to create a final list, the application can generate the best in-store route to retrieve the items. The application can still retrieve and still show the items not accepted, in case the consumer wants to reconsider an item while shopping.

The consumer now has a highly evolved shopping plan, which takes into consideration various product criteria and provides a targeted in-store route by which to retrieve the items. As the consumer follows the in-store route and collects items from the final list, he can indicate through his smartphone that the items have been collected. He may also encounter an item on the final list that he decides not to purchase. For example, he might remember that he already has a particular item at home, in which case he can create a modified final list by deleting the item. The application could then generate a new in-store route based upon the modified final list, which includes the remaining items and the consumer's current location. Alternatively, he may utilize his smartphone to read dynamic labeling comprising a QR code with the item's dynamic information identifier and URL to the nutritional substance information module to retrieve source or ΔN information regarding an item from the nutritional substance information module and decide he is no longer interested and would rather consider a previously identified alternative item. In this case, he could create a modified final list by accepting the alternative item still shown on the final list and unselecting the item he has lost interest in. The application could then generate a new in-store route based upon the modified final list, which includes the newly accepted item, the remaining items, and the consumer's current location. In still another alternative, the consumer may remember an item that was not originally on his shopping list and add it to the final list, creating a modified final list. The application could then generate a new in-store route based upon the modified final list, which includes the newly added item, the remaining items, and the consumer's current location.

Rebates related to transactions resulting from or assisted by the use of the application could be structured in various ways. For example, rebates could be based simply on a rebate per purchase methodology. Rebates might be structured depending upon hierarchy of the item on the consumer's shopping list, for example depending upon if the purchased item was a primary shopping list item, an alternative item, or a complimentary item. Rebates could be related to the purchase of information-enabled nutritional substances. Rebates could be related to specific supplier or in-store promotions presented to the consumer through the application.

After check out, the consumer can scan the receipt using his smartphone and transmit the information regarding purchases resulting from or assisted by the use of the application to a redemption resource, which could be the application provider. Alternatively, the supermarket could transmit this information along with a consumer identification code. This would ideally enable the application provider to redeem fees from the suppliers of the items purchased. The application provider would in turn provide the appropriate rebates to the consumer. The consumer rebates may take any number of forms, including direct deposit to a consumer account, periodic checks, or credit codes redeemable at suppliers or supermarkets participating in the application rebate program. Further, the application provider could provide monetary compensation to the retailer or supermarket for transactions resulting from or assisted by the use of the application. These transaction-based services are enhanced by the usage of ambient magnetic field anomaly-based positioning technology, since the routing to products is independent of in-store communication systems provided by a retailer and, also, independent of systems based upon GPS or other triangulation technologies. Thus, the transaction-based services using ΔN information can be readily associated with, or coupled to, the application using the ambient magnetic field anomaly-based positioning technology.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶6 will begin with the words “means for.” Accordingly, the applicant reserves the right to add additional claims after filing the application to pursue such additional claim forms for other aspects of the invention.

1. A system for providing particular information regarding nutritional substances, the system comprising:
a first database that collects particular information for nutritional substances, wherein the particular information is collected from at least two of a creator, preserver, transformer, conditioner, and consumer;
a second database that collects at least one of an initial nutritional and organoleptic value, as well as at least one ΔN value for the nutritional substance; and
means for providing ΔN values for the nutritional substances responsive to requests.

2. An information system for nutritional substances according to claim 1 wherein the first database collects source information for the nutritional substances.

3. An information system for nutritional substances according to claim 1 wherein:
said means for providing ΔN values for the nutritional substances responsive to requests is referenced to at least one of source information for the nutritional substance and a dynamic information identifier.

4. An information system for nutritional substances according to claim 3 wherein:
said means for providing ΔN values for the nutritional substances responsive to requests is referenced to an entity by referencing at least one of said source information and the dynamic information identifier.

5. An information system for nutritional substances according to claim 1 wherein the first database collects information from at least one of a source of origin and creation information.

6. An information system for nutritional substances according to claim 1 wherein:
said information is transmitted to at least one of a creator, preserver, transformer, conditioner, and consumer.

7. An information system for nutritional substances according to claim 1 wherein:
said particular information includes label content for the nutritional substance.

8. A method for tracking changes in a nutritional substance comprising:
assigning a dynamic information identifier to a nutritional substance;
determining an initial nutritional or organoleptic value of the nutritional substance;
determining a change value indicative of a change in the initial nutritional or organoleptic value;
associating the change value with the dynamic information identifier;
and
responsive to a request referenced to said dynamic information identifier,
transmitting the change value.

9. The method of claim 8, wherein determining the change value comprises
measuring at least one quality of the nutritional substance.

10. The method of claim 8, wherein:
determining the change value is based upon at least one of experimental data, measurement and observation of other nutritional substances, and historical data.

11. The method of claim 8, wherein:
in response to a request about conditioning of the nutritional substance, providing informational values of changes of at least one of the nutritional or organoleptic values.

12. The method of claim 8, further comprising providing an indication of a date of said change in the initial nutritional or organoleptic value.

13. The method of claim 8, further comprising gathering and providing dynamic label information regarding adulteration of the nutritional substance.

14. The method of claim 8, further comprising gathering and providing dynamic label information regarding a substance other than said nutritional substance.

15. The method of claim 8, further comprising providing date-effective information as to the nutritional substance.

16. A method of providing dynamic labeling content for a nutritional substance comprising:
determining an initial non-static nutritional or organoleptic value of the nutritional substance;
assigning a dynamic information identifier to the determined initial non-static nutritional or organoleptic value;
transmitting values referenced to said dynamic information identifier and corresponding to at least one of the initial nutritional or organoleptic value of the nutritional substance,
estimating changes to said non-static nutritional or organoleptic values of the nutritional substance; and
responsive to a request referenced to said dynamic information identifier, transmitting the estimated values of said estimated changes for providing dynamic labeling content for the nutritional substance.

17. The method of claim 16, wherein estimating changes comprises:
measuring at least one quality of the nutritional substance.

18. The method of claim 16, wherein:
estimating changes is based upon at least one of experimental data, measurement and observation of other nutritional substances, and historical data.

19. The method of claim 16, wherein:
in response to a request about conditioning of the nutritional substance, providing informational values of changes of at least one of the nutritional or organoleptic values.

20. The method of claim 16, further comprising providing an indication of a date of said change in the non-static nutritional or organoleptic value.

21. The method of claim 16, further comprising gathering and providing dynamic label information regarding adulteration of the nutritional substance.

22. The method of claim 16, further comprising gathering and providing dynamic label information regarding a substance other than said nutritional substance.

23. The method of claim 16, further comprising providing date-effective information as to the nutritional substance.

24. The method of claim 16, further comprising determining a dynamic expiration date as a function of said estimated changes.

25. The method of claim 8, further comprising determining a dynamic expiration date as a function of said change value.
